(19) United States
(12) Patent Application Publication
(10) Pub. No.: US 2025/0246201 A1
(43) Pub. Date: Jul. 31, 2025

(54) SYSTEMS AND METHODS FOR INTELLIGENT SPEECH TARGETING

(71) Applicant: NUREVA, INC., Calgary (CA)

(72) Inventors: Richard Dale FERGUSON, Okotoks (CA); Saeid Reza SEYDNEJAD, Markham (CA); Michael Edmund KNAPPE, West Bloomfield, MI (US)

(21) Appl. No.: 19/037,590

(22) Filed: Jan. 27, 2025

Related U.S. Application Data
(60) Provisional application No. 63/625,474, filed on Jan. 26, 2024.

(51) Int. Cl. G10L 25/84; G10L 25/21; G10L 25/30; H04N 23/90; H04R 1/40; H04R 3/00

(52) U.S. Cl. CPC G10L 25/84; G10L 25/21; G10L 25/30; H04N 23/90; H04R 1/406; H04R 3/005; H04R 2201/401

(57) ABSTRACT

The artificial intelligence (AI-VAD) engine utilizes virtual microphone (bubble) map processing for continuous acoustic energy location tracking throughout a room. A virtual microphone can be placed anywhere in the room and tracked based on acoustic energy location identification. A noise discriminator determines whether the acoustic energy is speech or a non-speech noise source. This allows talker location(s) to be accurately tracked in real-time while non-speech noise sources are ignored. The tracked talker location(s) can be used to accurately position cameras on the speaker for use with unified communication clients.

### CROSS-REFERENCE TO RELATED APPLICATIONS

This application claims priority to U.S. Provisional Application Ser. No. 63/625,474, filed Jan. 26, 2024, the entire contents of which are hereby incorporated by reference in their entirety.

### BACKGROUND OF THE INVENTION

Automated conference room camera switching is a technique that utilizes multiple video cameras in a conference room to visually cover multiple areas of interest by automatically switching camera views as triggered by events happening in the room. A common trigger is the identification of a current talker and switching to a camera that includes a view of that person. That location identification of a talker is often done either through the localization of active speech energy and/or visual cues that a person is speaking.

### SUMMARY OF THE INVENTION

The purpose of the disclosed invention is to create an intelligent AI-VAD (Artificial Intelligent Voice Activity Detection) model, decision logic and processor integrated into an audio processor for the purposes of targeting, identifying and selecting cameras and/or camera zones thus using the audio processor to validate speech event sound source locations while ignoring and/or defocusing invalid and undesired sound events in the room, creating a seamless experience for the remote participants while continually tracking and focusing audio and video only on the desired speech event (participants) in the room whether they are speaking or not speaking.

Conference room video conferencing systems placed in larger multi-participant meeting rooms can utilize multiple video cameras to capture different angles of the room and different participants. One desired behavior of these systems is to automatically switch to a camera view that when a person speaks, captures a visual view of that person speaking. This has been done in current state of the art implementations through determination of the direction or coordinates through visual cues (e.g. moving lips) and/or speech energy signatures captured through microphone placement and directional processing. To avoid cameras being chosen and focused towards inadvertent noise or participants not to be included in a video feed, current state of the art systems have defined positional ‘zones’ in rooms where camera views will be chosen only if sound activity occurs in those zones.

One of the challenges in these zone-based systems is that a) visual talker determination systems are not always able to clearly see participants' faces to determine if lips are moving—and need to also rely on audio cues, and b) active participants in a valid camera zone sometimes don't speak but can make noise that can inadvertently trigger a camera view change. For the latter condition, past implementations have used frequency-based filtering and energy-based detection to determine the presence of speech and a valid talker versus a noise source. Unfortunately, many common noise sources such as keyboard typing and crinkling bags have similar mid-range frequency content and non-stationary energy envelopes to speech, noise sources which are also co-located with conference participants who are causing the noise.

This invention leverages a trained machine learning construct as a speech/noise discriminator to significantly reduce false camera switching triggers on noise sources. It is constructed to operate in near-real-time to ensure camera switching to valid speech sources occurs in a timely fashion as expected by the camera switching timing norms established over decades of broadcast video.

These zone-based voice pick-up and amplification implementations suffer from several performance constraints. They are typically constrained to very large, acoustically treated rooms to maintain a minimum distance between the talker and amplified zones to minimize the potential for perceptually disruptive echo (both back to the talker and listener), and to eliminate the possibility of gain instability and feedback between the amplified loudspeakers and microphone pickup. Current pre-configured zone-based designs are also constrained in their ability to track talkers-requiring talkers to remain in their pre-configured zones or face potential pickup discontinuities in crossing zone boundaries.

This invention leverages the following techniques in a novel manner to overcome these constraints. These techniques include:
1) Virtual Microphone (bubble) map processing for continuous acoustic energy location tracking throughout a room.
2) A virtual microphone placed anywhere in the room based on the acoustic energy location identification.
3) An ML trained speech/noise discriminator that takes the sampled output of the virtual microphone and determines whether the incoming signal is speech or a non-speech/noise source.
4) The construction and delivery of an API data schema that delivers the current talker location(s) in the room to the camera switching and tracking system when valid speech is detected, with no update sent if noise is detected.

### BRIEF DESCRIPTION OF THE DRAWINGS

FIGS. 1a & 1b show examples of rooms typical to deploy the disclosed invention.

FIG. 2 illustrates the differences between direct verses reflected sound in a room.

FIG. 3a is, respectively, prior art illustrative diagram of virtual microphones distributed in the shared space.

FIG. 3b illustrates a top-down view of a room showing the distribution of virtual microphones throughout the room using a virtual microphone array.

FIG. 4 shows a top-down view of a room using a beamforming array and generalized lobing patterns throughout the room.

FIGS. 5a & 5b are structural drawings of typical microphone/speaker bar & microphone array layouts.

FIGS. 6a, 6b, 6c, and 6d show microphone/speaker bar and camera arrangements supported by the disclosed invention.

FIG. 7 shows camera AI-VAD selective targeting with a single microphone/speaker bar and camera arrangement supported by the disclosed invention.

FIGS. 8a & 8b show camera AI-VAD selective targeting of speech sounds across two camera zones with multiple subzones using multiple microphone/speaker bar and camera arrangements supported by the disclosed invention.

FIGS. 9a & 9b show camera AI-VAD selective targeting of speech sounds across two camera zones with multiple subzones using a plurality of microphone/speaker bars and cameras arrangements tracking a moving sound source supported by the disclosed invention.

FIGS. 10a & 10b, show the primary processing components of the disclosed invention and an alternate implementation.

FIGS. 11a & 11b Targeting Processor shows the targeting processor of the disclosed invention.

FIGS. 12a & 12b System Logic Diagram shows the logic diagram of the disclosed invention and an alternate implementation.

FIG. 13a AI-VAD Engine show the structural layout of the voice activity detector of the disclosed invention.

FIG. 13b Feature Extraction shows feature extraction module.

FIG. 13c Audio Sample shows a typical audio sample used for feature extraction.

FIG. 13d Neural Classifier & showing the neural engine structure.

FIG. 13e illustrates the data labeling procedure used to classify voice vs no voice in the audio data set

FIG. 13f Matlab Training Model shows the Matlab model used.

FIG. 13g Post-Processing shows the functional structure of the post-processing processor.

FIG. 14a function layout of the Training model process used to train the AI-VAD Processor.

FIGS. 14b, 14c, and 14d graphs showing typical noise profiles used for training.

FIG. 14e Epoch learning curve shows the Epoch learning curve results.

FIG. 14f Confusion Matrix shows the results of the confusion matrix from the training program.

FIGS. 15a, 15b, 15c, 15d, and 15e demonstrate screen captures of a video of the disclosed invention actively working.

In one or more implementations, not all of the depicted components in each FIG. may be required, and one or more implementations may include additional components not shown in a FIG. Variations in the arrangement and type of the components may be made without departing from the scope of the subject disclosure. Additional components, different components, or fewer components may be utilized within the scope of the subject disclosure.

### DETAILED DESCRIPTION

A “microphone” in this specification may include, but is not limited to, one or more of, any combination of transducer device(s) such as, microphone element, condenser mics, dynamic mics, ribbon mics, USB mics, stereo mics, mono mics, shotgun mics, boundary mic, small diaphragm mics, large diaphragm mics, multi-pattern mics, strip microphones, digital microphones, fixed microphone arrays, dynamic microphone arrays, beamforming microphone arrays, and/or any transducer device capable of receiving acoustic signals and converting to electrical signals, and or digital signals.

A “virtual microphone” (bubble) in this specification represents a point in space that has been focused on by the combined microphone array by time-aligning and combining a set of physical microphone signals according to the time delays based on the speed of sound and the time to propagate from the sound source each to physical microphone.

A “combined array” in this specification can be defined as the combining of two more individual microphone elements, groups of microphone elements and other combined microphone elements into a single combined microphone array system that is aware of the relative distance between each microphone element to a reference microphone element, determined in configuration, and is aware of the relative orientation of the microphone elements such as a m-axis, m-plane and m-hyperplane sub arrangements of the combined array. A combined array will integrate all microphone elements into a single array and will be able to form coverage pattern configurations as a combined array.

A “communication connection” in this specification may include, but is not limited to, one or more of or any combination of network interface(s) and devices(s) such as, Wi-Fi modems and cards, internet routers, internet switches, LAN cards, local area network devices, wide area network devices, PSTN, Phone networks, etc.

A “device” in this specification may include, but is not limited to, one or more of, or any combination of processing device(s) such as, a cell phone, a Personal Digital Assistant, a smart watch or other body-borne device (e.g., glasses, pendants, rings, etc.), a personal computer, a laptop, a pad, a cloud-access device, a white board, and/or any device capable of sending/receiving messages to/from a local area network or a wide area network (e.g., the Internet), such as devices embedded in cars, trucks, aircraft, household appliances (refrigerators, stoves, thermostats, lights, electrical control circuits, the Internet of Things, etc.).

A “participant” in this specification may include, but is not limited to, one or more of, any combination of persons such as students, employees, users, attendees, or any other general groups of people that can be interchanged throughout the specification and construed to mean the same thing. Who gathering into a room or space for the purpose of listening to and or being a part of a classroom, conference, presentation, panel discussion or any event that requires a public address system and a UCC connection for remote participants to join and be a part of the session taking place. Throughout this specification a participant is a desired sound source, and the two words can be construed to mean the same thing.

A “desired sound source” in this specification may include, but is not limited to, one or more of a combination of audio source signals of interest such as: sound sources that have frequency and time domain attributes, specific spectral signatures, and/or any audio sounds that have amplitude, power, phase, frequency and time, and/or voice characteristics that can be measured and/or identified such that a microphone can be focused on the desired sound source and said signals processed to optimize audio quality before delivery to an audio conferencing system. Examples include one or more speaking persons, one or more audio speakers providing input from a remote location, combined video/audio sources, multiple persons, or a combination of these. A desired sound source can radiate sound in an omni-polar pattern and/or in any one or combination of directions from the center of origin of the sound source.

An “undesired sound source” in this specification may include, but is not limited to, one or more of a combination of persistent or semi-persistent audio sources such as: sound sources that may be measured to be constant over a configurable specified period of time, have a predetermined amplitude response, have configurable frequency and time domain attributes, specific spectral signatures, and/or any audio sounds that have amplitude, power, phase, frequency and time characteristics that can be measured and/or identified such that a microphone might be erroneously focused on the undesired sound source. These undesired sources encompass, but are not limited to, Heating, Ventilation, Air Conditioning (HVAC) fans and vents; projector and display fans and electronic components; white noise generators; any other types of persistent or semi-persistent electronic or mechanical sound sources; external sound source such as traffic, trains, trucks, food sounds, chair sounds, mechanical keyboard typing, crinkling of bags etc.; and any combination of these. An undesired sound source can radiate sound in an omni-polar pattern and/or in any one or combination of directions from the center of origin of the sound source.

A “system processor” is preferably a computing platform composed of standard or proprietary hardware and associated software or firmware processing audio and control signals. An example of a standard hardware/software system processor would be a Windows-based computer. An example of a proprietary hardware/software/firmware system processor would be a Digital Signal Processor (DSP).

A “communication connection interface” is preferably a standard networking hardware and software processing stack for providing connectivity between physically separated audio-conferencing systems. A primary example would be a physical Ethernet connection providing TCP/IP network protocol connections.

A “Unified Communication Client” (UCC) is preferably a program that performs the functions of but not limited to messaging, voice and video calling, team collaboration, video conferencing and file sharing between teams and or individuals using devices deployed at each remote end to support the session. Sessions can be in the same building and/or they can be located anywhere in the world that a connection can be establish through a communications framework such but not limited to WiFi, LAN, Intranet, telephony, wireless or other standard forms of communication protocols. The term “Unified Communications” may refer to systems that allow companies to access the tools they need for communication through a single application or service (e.g., a single user interface). Increasingly, Unified Communications have been offered as a service, which is a category of “as a service” or “cloud” delivery mechanisms for enterprise communications (“UCaaS”). Examples of prominent UCaaS providers include Dialpad, Cisco, Mitel, RingCentral, Twilio, Voxbone, 8×8, and Zoom Video Communications.

An “engine” is preferably a program that performs a core function for other programs. An engine can be a central or focal program in an operating system, subsystem, or application program that coordinates the overall operation of other programs. It is also used to describe a special-purpose program containing an algorithm that can sometimes be changed. The best-known usage is the term search engine which uses an algorithm to search an index of topics given a search argument. An engine is preferably designed so that its approach to searching an index, for example, can be changed to reflect new rules for finding and prioritizing matches in the index. In artificial intelligence, for another example, the program that uses rules of logic to derive output from a knowledge base is called an inference engine.

As used herein, a “server” may comprise one or more processors, one or more Random Access Memories (RAM), one or more Read Only Memories (ROM), one or more user interfaces, such as display(s), keyboard(s), mouse/mice, etc. A server is preferably apparatus that provides functionality for other computer programs or devices, called “clients.” This architecture is called the client-server model, and a single overall computation is typically distributed across multiple processes or devices. Servers can provide various functionalities, often called “services”, such as sharing data or resources among multiple clients, or performing computation for a client. A single server can serve multiple clients, and a single client can use multiple servers. A client process may run on the same device or may connect over a network to a server on a different device. Typical servers are database servers, file servers, mail servers, print servers, web servers, game servers, application servers, and chat servers. The servers discussed in this specification may include one or more of the above, sharing functionality as appropriate. Client-server systems are most frequently implemented by (and often identified with) the request-response model: a client sends a request to the server, which performs some action and sends a response back to the client, typically with a result or acknowledgement. Designating a computer as “server-class hardware” implies that it is specialized for running servers on it. This often implies that it is more powerful and reliable than standard personal computers, but alternatively, large computing clusters may be composed of many relatively simple, replaceable server components.

The servers and devices in this specification typically use one or more processors to run one or more stored “computer programs” and/or non-transitory “computer-readable media” to cause the device and/or server(s) to perform the functions recited herein. The media may include Compact Discs, DVDs, ROM, RAM, solid-state memory, or any other storage device capable of storing the one or more computer programs.

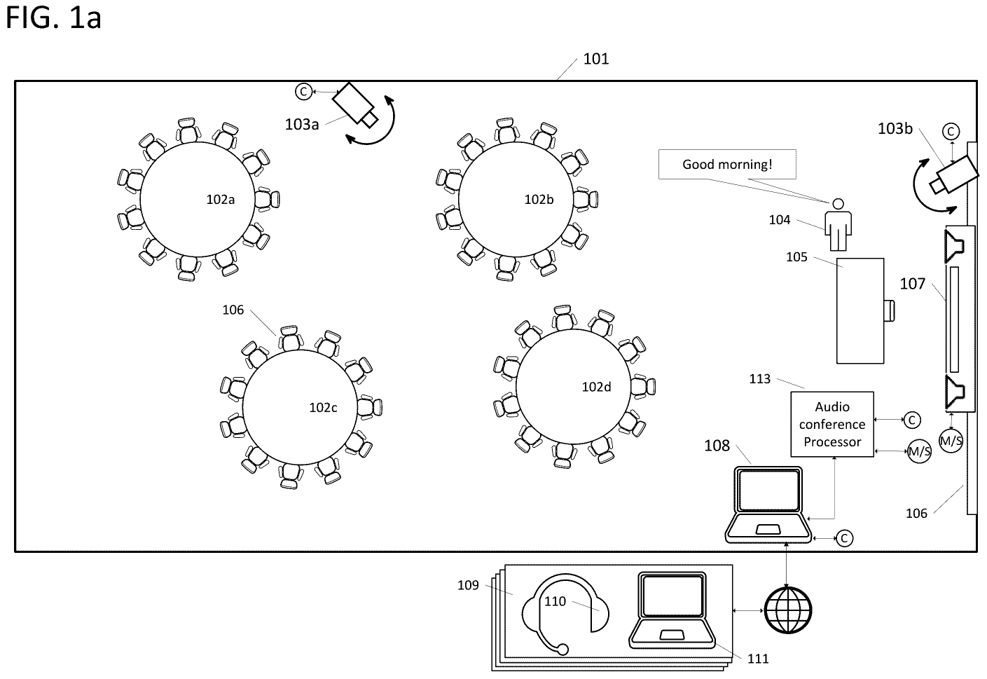

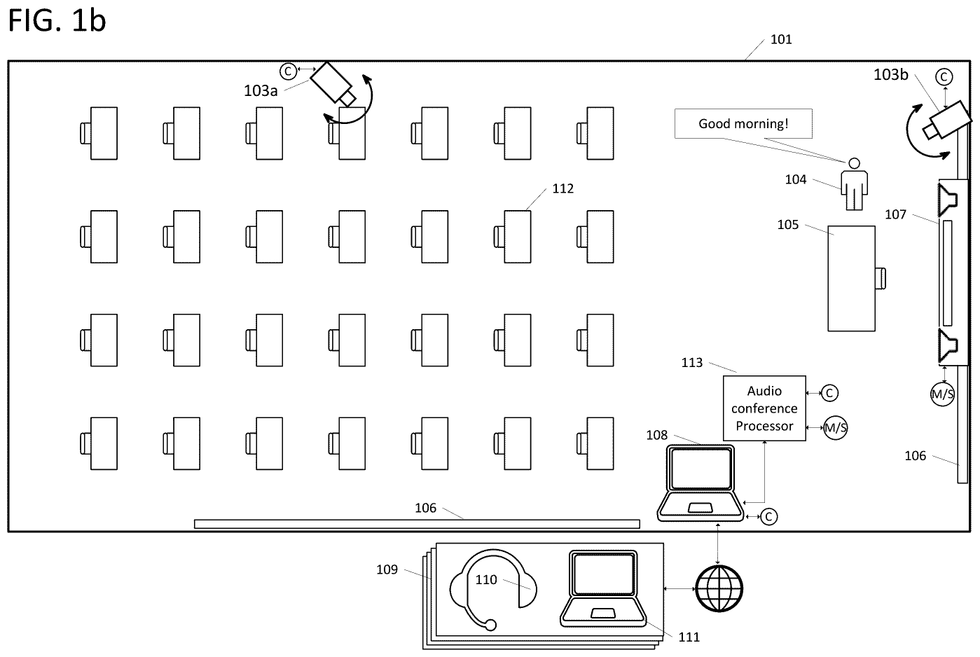

With reference to FIG. 1a, shown is an example of a typical presentation room. FIG. 1a, corresponding to a shared 3D space 101. Shared 3D space, shared space, room, venues, classroom theatre, presentation space and similar can be used interchangeably and are to be construed to mean the same thing and fully supported by the disclosed invention. The room 101 is a typical layout of a presentation room containing tables 102a-d, presentation desk 105 and a presenter 104. Presenter, facilitator, teacher, talker, active talker, desired sound source and similar can be used interchangeably and construed to mean the same thing throughout the specification.

Current expectations are that events held in venues such as the one illustrated in FIG. 1a are expected to be technology enabled with multimedia capabilities to pick up, record and transmit the event to any number of remote participants 109 that will use audio/video equipment such as but not limited to headphones 110 and computers 111 to view the event without having to be physically present within the room 101.

To support remote presentation capabilities the room 101 will typically contain any number of video cameras 103a-103b that can be fixed or manually steered to the active talker in the room 101 that is typically the presenter 104. To pick up the audio a microphone and speaker system 107 is installed and through an Audio Conference Processor 113 the audio and video is integrated and sent to a computer 108 that is used to transmit the UCC session via standard internet communication protocols to the remote participants 109.

With reference to FIG. 1b, a classroom 101 is shown to capture another typical usage application of the same multimedia technology to transmit in room 101 UCC events to remote students 109.

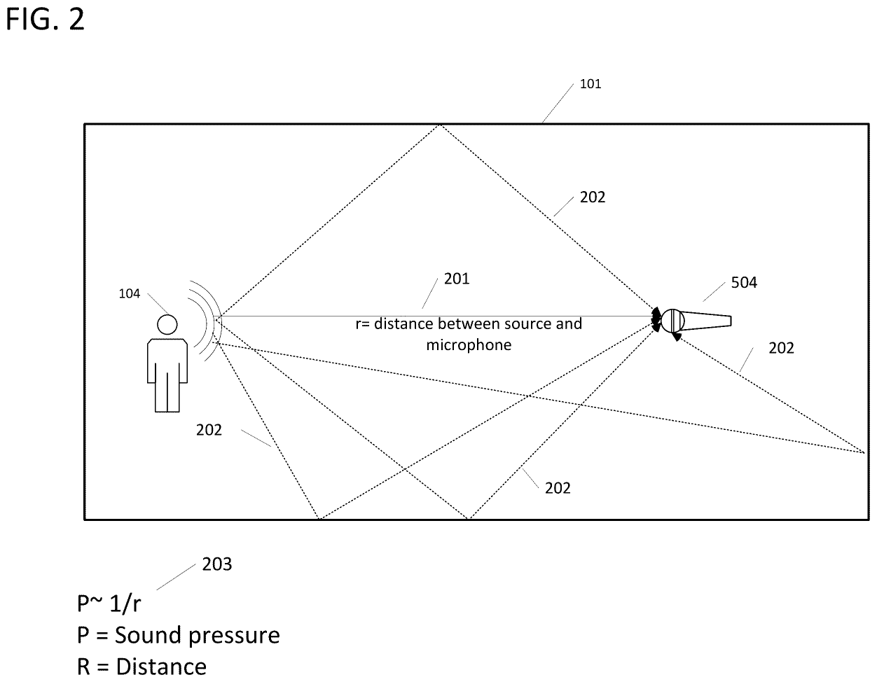

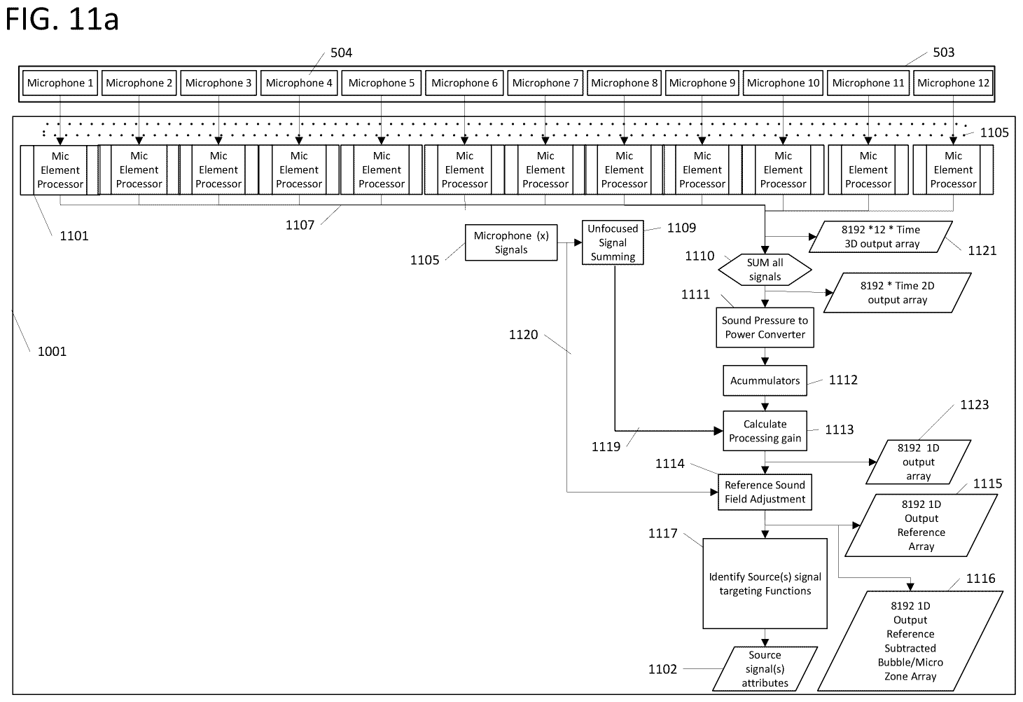

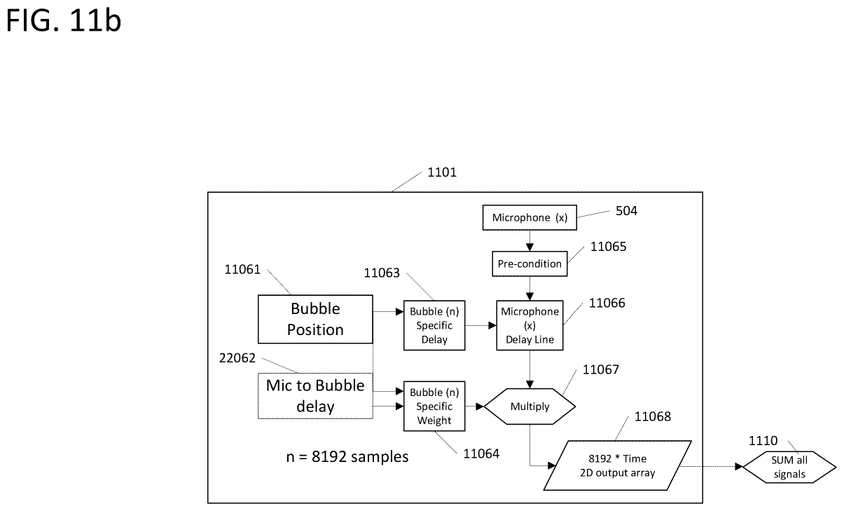

With reference to FIG. 2, illustrates a basic concept to support virtual microphones 302 in the 3D space 101. As a microphone 504 is physically separated through distance from the sound source 104, the direct path's 201 sound pressure level drops predictably following the 1/r rule 203, however the accumulation of the reflected paths 202 tend to fill the room 101 more evenly. As one moves the microphone 504 further from the sound source 104, the reflected sound waves 202 make up more of the microphone 504 measured signal. The measured signal sounds much more distant and harder to hear, even if it has sufficient amplitude, as the reflected sound waves 202 are dispersed in time, which causes the signal to be distorted, and effectively not as clear to a listener 109. The bubble processor illustrated in FIG. 11 further elaborates on this principle to form the audio targeting solution supported in the preferred embodiment of the disclosed invention.

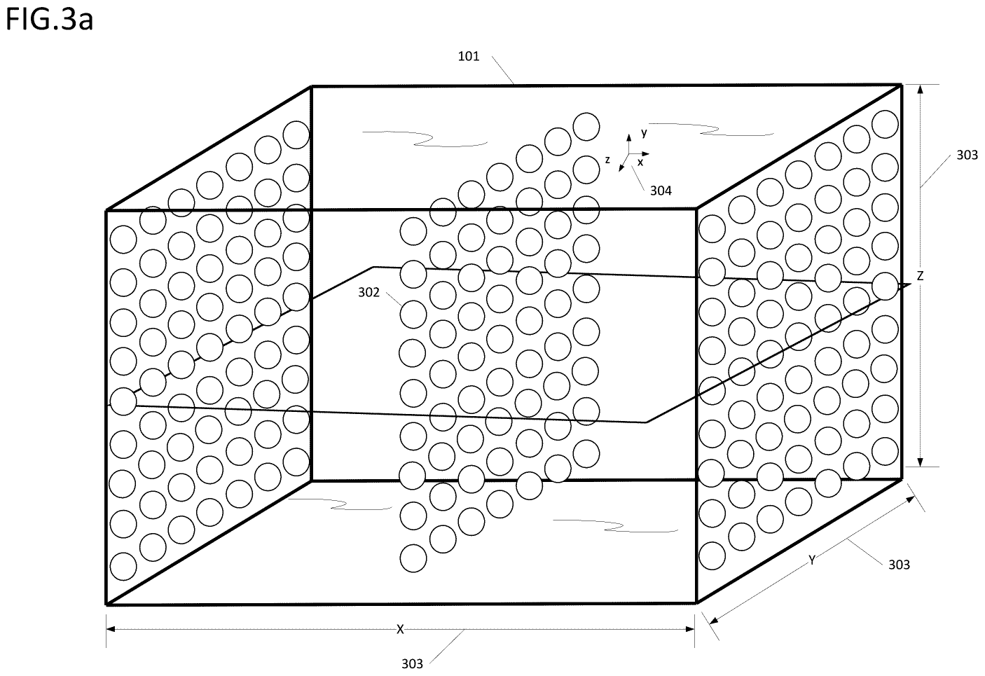

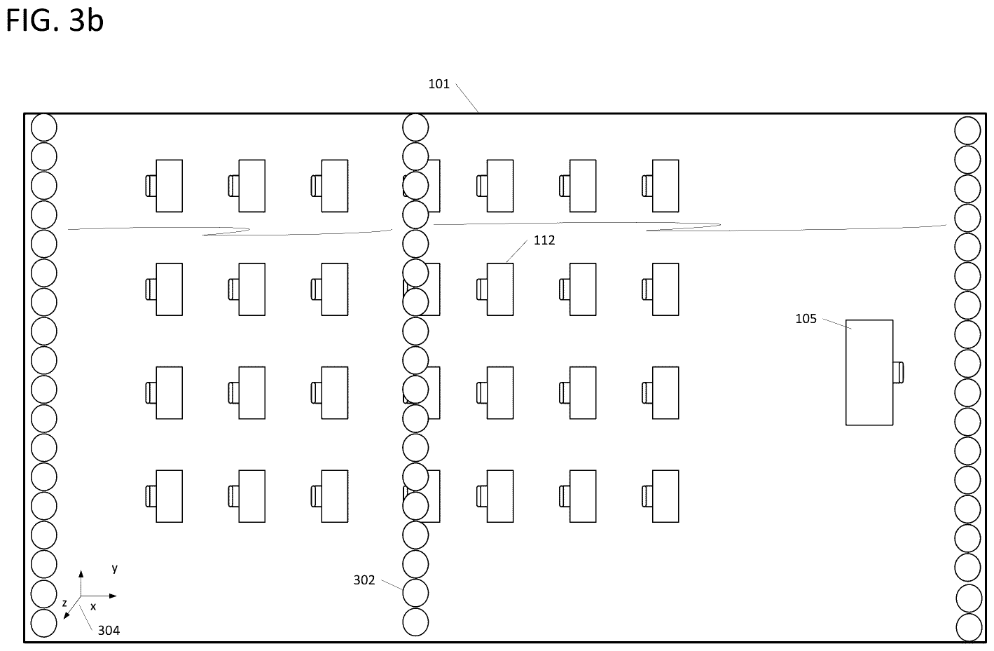

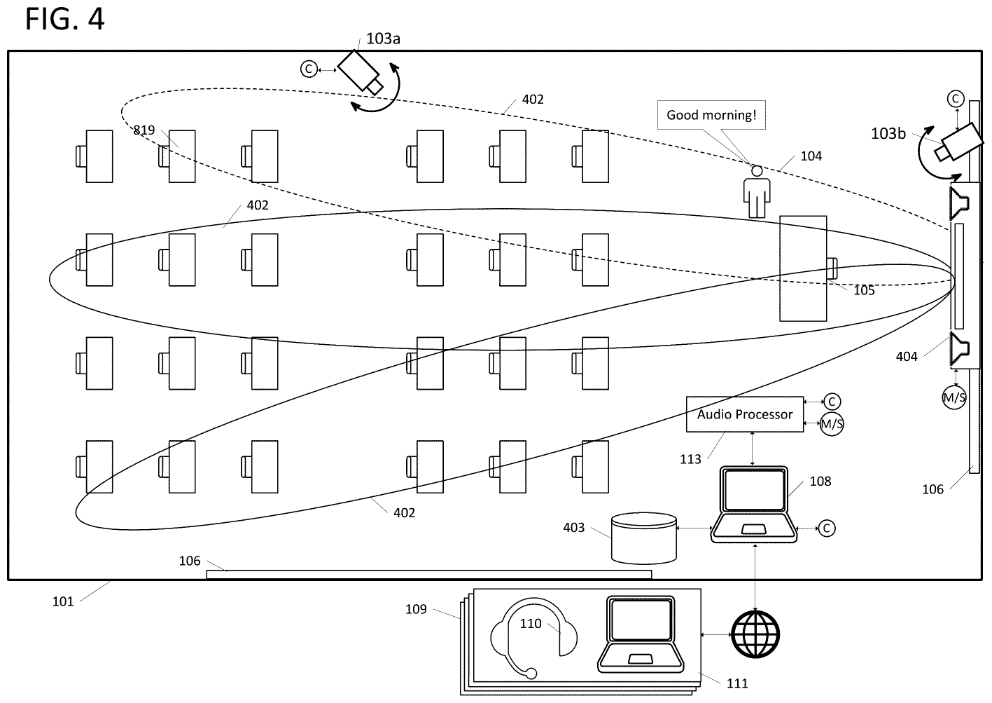

With reference to FIG. 3a, illustrated is a room 101 of any dimension that is volumetrically filled with virtual microphone bubbles 302. Such a system is described in detail in U.S. Pat. No. 10,063,987, issued Aug. 28, 2018 and entitled “Method, Apparatus, and Computer-Readable Media for Focusing Sound Signals in a Shared 3D Space,” (referred to herein as “the '987 patent”) which is hereby incorporated by reference. The Bubble (targeting) processer system FIG. 11a as presently preferred is set up (but not limited) to measure thousands of concurrent virtual microphone bubbles 302. The illustration only shows a subset of the virtual microphone bubbles 302 for clarity. The room 101 is filled such that from a volumetric perspective all volume is covered with the virtual microphone bubbles 302 which are arranged in a 3D grid with (X, Y, Z) vectors 303 to an individual (X, Y, Z) location 304 in the room 101. By deriving the Processing Gain 1113 in FIG. 11a sourced from each virtual microphone bubble 302 location 304, the exact coordinates 303 of the sound source 104 can be measured in an (X, Y, Z) coordinate grid 303. This allows for precise location determination to a high degree of accuracy, which is limited by virtual microphone bubble 302 size. The virtual microphone bubble 302 size and position 304 of each virtual microphone 302 is pre-calculated based on room 101 size and bubble 302 size desired which is configurable. The virtual microphone bubble 302 parameters include, but are not limited to, size and coordinate position 304. The parameters are utilized by the target (bubble) processor system 1001 (FIG. 11a) throughout the calculation process to derive magnitude and positional information for each virtual microphone bubble 302 position 304. With whole room 101 microphone coverage there is no specific need to configure the Audio Processor 603, and there are not coverage zone limitations illustrated in the beam former FIG. 4 coverage patterns 402 or with discrete microphones.

With reference to FIG. 3b, shown is a top-down view of a classroom 101. Virtual microphones 302 are spread evenly throughout the room 101. Not all virtual microphones 302 are shown for clarity however it should be interpreted that the room 101 is volumetrically filled with virtual microphones 302 ensuring that any desired sound source 104 can be located using the virtual microphone array 503.

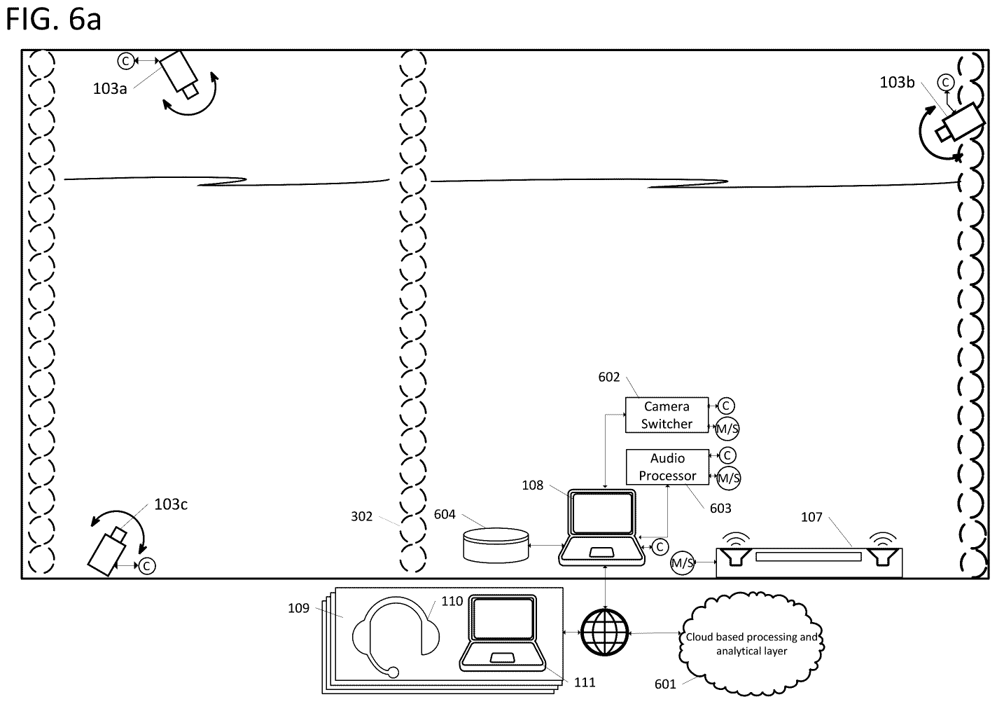

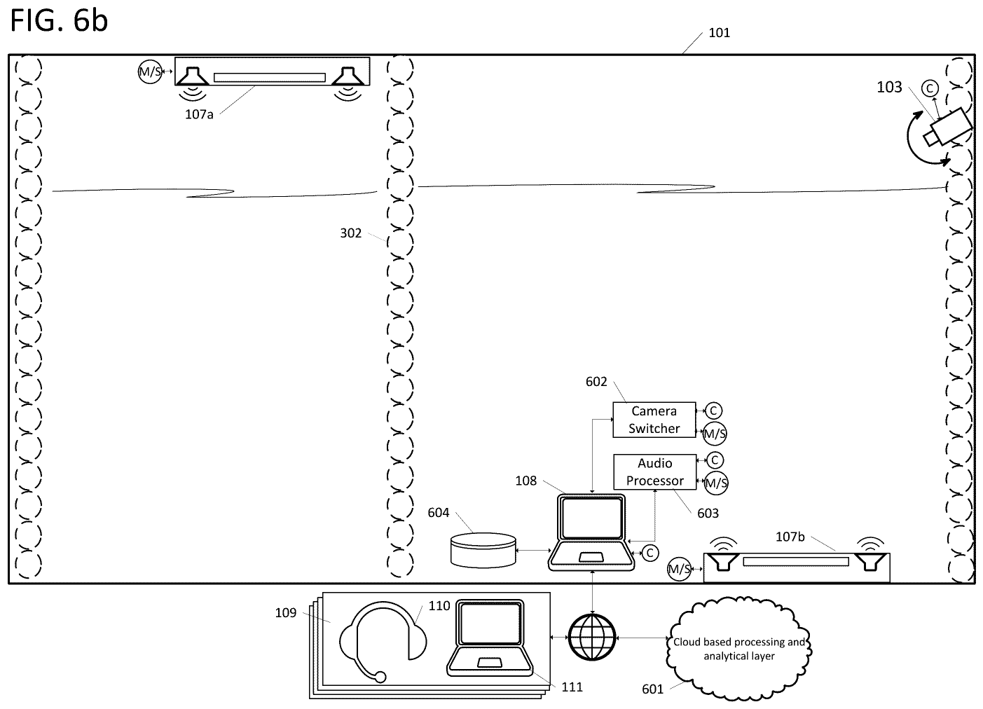

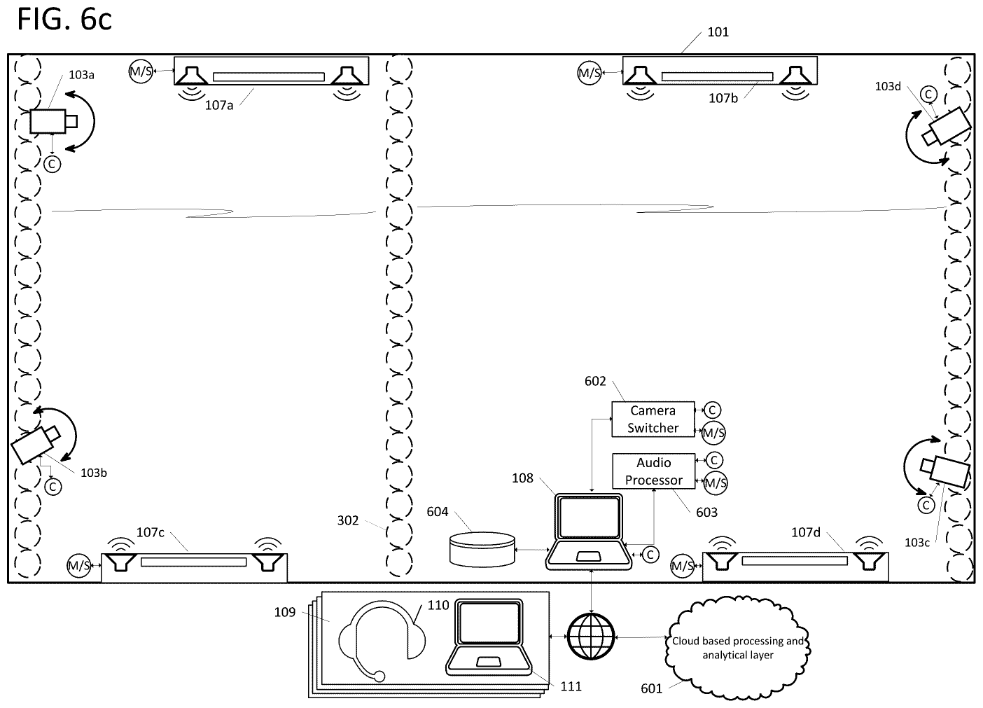

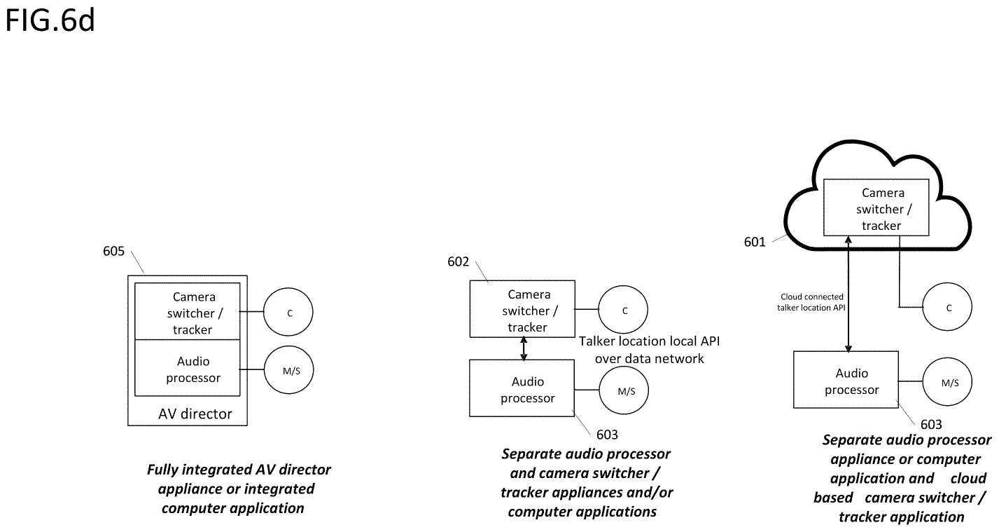

With reference to FIG. 4, shown is a top-down view of a classroom 101 utilizing a beamformer array 404. The beamformer can have a plurality of configurations and lobe 402 arrangements. With respect to the present invention a beamformer 404 that is able to send angle information (coordinate angles) and/or location information of selected sound sources to the Audio Processor 603 (FIG. 6a) is fully supported and should be considered within scope of the present invention.

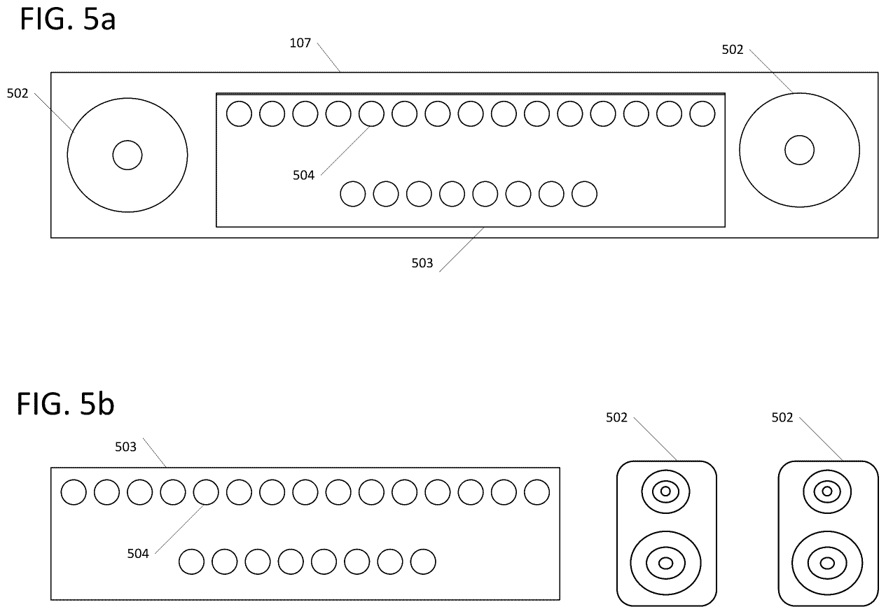

With reference to FIGS. 5a and 5b, outlined are two structural microphone and speaker arrangements that are supported by the preferred embodiment. FIG. 5a illustrates a combined plurality of microphones 504 arranged into a microphone array 503 and an integrated dual speaker 502 system that can be installed in a room 101. The microphones 504 are arranged to create a microphone array 503 that supports the creation of the virtual microphone 302 grid with 1000's of virtual microphones 302 distributed throughout the room 101 as further detailed in FIG. 11 (target processer). The microphone array 503 and the speakers 502 can be collocated in the same chassis 107 or they can be separated out into the individual constituent hardware functions as illustrated in FIG. 5b without affecting the preferred embodiment. Either arrangement is fully supported. The number of microphones 504 is not constrained in maximum number however, there needs to be a sufficient number of at least two (2) or more and even more preferably three (3) or more to form a microphone array 503 to create a virtual microphone 302 bubble map as illustrated in FIG. 3a. The number of speakers 502 implemented is not a limiting factor and there is no requirement for a speaker 502 to be installed in the room 101. The number of speakers 502 will preferably be determined by the size of the room 101 and the appropriate sound level the room 101 usage scenario is required to achieve. The number of speakers 502 and their locations are not germane for the disclosed invention and are only included to show a typical conference system arrangement.

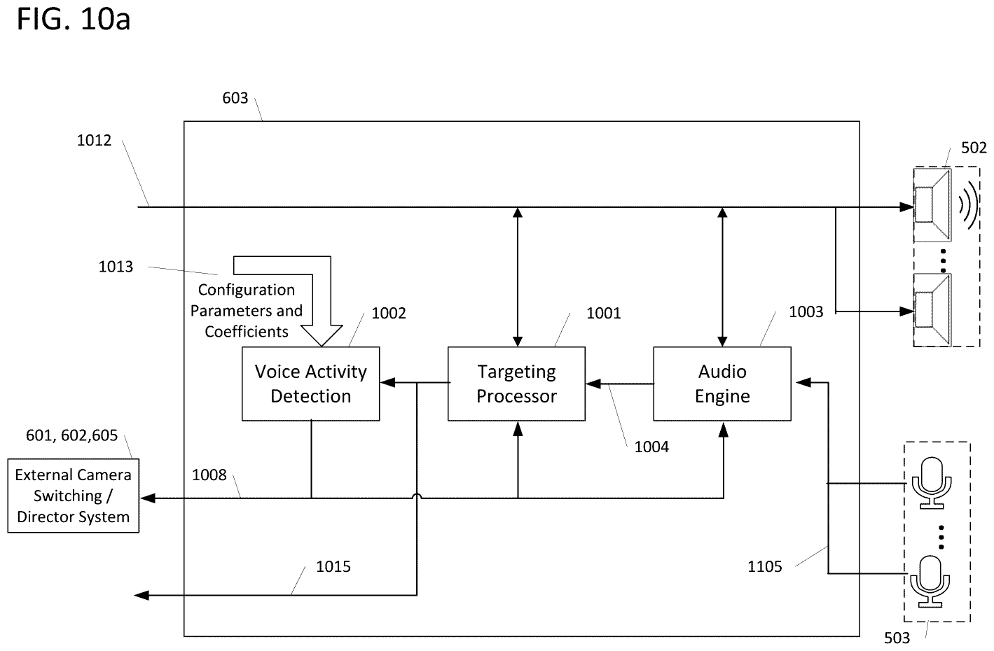

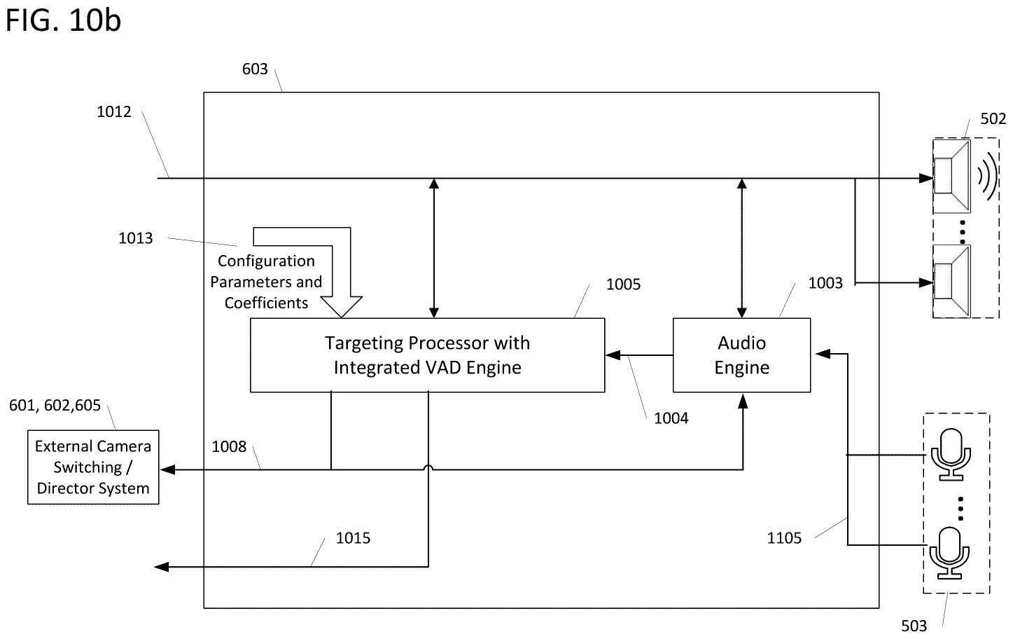

With reference to FIG. 6a, shown is a layout example of the disclosed invention utilizing a single microphone/speaker bar 107 and multiple cameras 103a-c which are connected to an Audio Processor 603. The Audio Processor 603 is a hardware and firmware device that is used to connect to the microphone/speaker bars 107, to the computer 108, and to other peripherals if not integrated such as but not limited to a camera director device 602 for the purpose of targeting audio by creating and monitoring a virtual microphone grid FIG. 3a or a beamformer array FIG. 4, then processing the audio and steering cameras 103a-c based on sound source 104 location 303 data derived from the targeting processor 1001 and sending the processed audio streams to the UCC clients using proprietary logic and firmware implementation described in FIGS. 10a-c & FIGS. 11a-b describing the disclosed invention. The Audio Processor 603 connects to the cameras 103a-c and the microphone/speaker bar 107 with industry standard bidirectional communication interface. The Audio Processor 603 is connected to a computer 108 which is conference enabled and runs any suitable UCC client that is able to make a connection to remote participants 109 for the purpose of transmitting the in-room 101 event connected to the internet. The cameras 103a-c are able to take instructions from the audio processer 603 and/or the computer 108 and/or the camera switcher/director processor 602 and/or via a cloud-based control process 601 for the purpose of being steered and configured based on the intelligent targeting algorithms 1001 executed by the Camera Director Processor 602 which may be located in or co-resident with the Audio Processer 603. An external storage device 604 is included to illustrate the capacity to record, store and house for example but not limited to audio data, video data, meta data describing the audio/video sessions, UC&C data, service and support data, targeting data and other similar analytical data that can be stored locally onsite, and/or in a cloud-based solution 601.

With continuing reference to FIG. 6b-c, shown are a multi-microphone/speaker bar 107a-b and 107a-d deployments in the room 101. More installed microphone/speaker bars improve room 101 coverage and location accuracy determination of the audio conference system. The same thing applies to cameras 103a-d. A minimum of one camera 103 is required and the maximum number of cameras 103a-d is a user driven hardware choice and not a constraint of the disclose invention. With more cameras 103a-d the audio conference system processor can utilize more camera zones and sub zones (presets) options to obtain the best video choices based on talking participant 104 location and facing direction in the room 101. The camera field of view can be narrowed down intelligently using the Voice Activity Detection (AI-VAD) processor 1002 in conjunction with the Camera Director Processor 602 to specific speech event locations 303 and as a result defocus and/or ignore non-speech event or transient sound events (undesired sound source), so they do not distract from the video experience at the remote participant 109 end of the session.

With continuing reference to FIG. 6d, shows that the camera 103a-c steering and switching logic can be distributed through a distributed processing and/or collocated architecture such as but not limited to integration into the audio processer 603, a standalone camera switcher 602, in a collocated computer 108 and/or a cloud based processor 601, an intelligent Audio Video Director 605 consisting of both an integrated camera switcher/tracker and audio processor, or any combination based on the appropriate design consideration of the specific deployment and be considered to be in scope of the disclosed invention. The camera switching logic contained in the Audio Processor 603 may also include an intelligent dwell (hysteresis) and/or speech pattern algorithms on the voice detection state to ensure that normal gaps in speech are not captured as non-voice events or quiet period in time, then reporting to the Camera Director Processor 602 a notification to switch to another participant 104. The intent is to consider normal speech patterns and pauses when reporting a change in location or sound event to prevent false switching events.

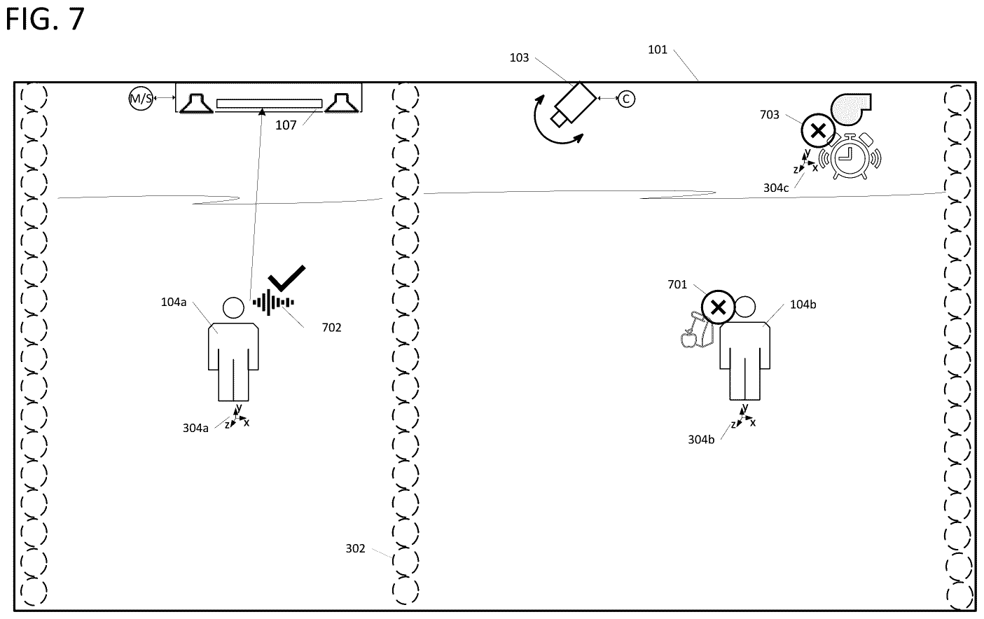

With reference to FIG. 7, the room 101 is configured with a single microphone/speaker bar 107 and a single pan-tilt-zoom (PTZ) camera 103. The audio conference processing and computer hardware have been removed for clarity. The room 101 has two speaking participants 104a, 104b. Participant 104a is talking and is recognized as a speech event 702 by the Audio Processor 603. Participant 104b is eating food 701 which produces transient noise events such as for example crinkling bag and wrapper sounds. The food 701 sounds are considered nonspeech, transient in nature and undesired sound sources. Typical audio conference systems in the art would pick-up the undesired sounds and most likely steer the camera 103 to participant 104b location 304b in the room 101. This would be an undesirable situation and would disrupt the video and audio flow to the remote participant 109 from the speaking 702 participant 104a. The disclosed invention prevents distractive events from bothering the remote participant 109. The AI-VAD engine 1002 will determine which sound event is speech (desired sound source) 702 and which sound event is not speech (undesired sound source) 701 and indicate this to the Camera Director processor 602 which will steer the PTZ camera 103 to the participant 104a speech event 702 at location 304a. While ignoring undesired sound source 104b and food sounds 701. The camera 103 will stay locked on the last known speech 702 speaking participant 702 in this case until such time that a new speech event is determined in the room 101 at which point the Audio Processor 603 with the AI-VAD engine 1002 and Camera Director Processor 602 will steer to the new speech determined location in the room 101. The statically located undesired sound sources 703 such as but not limited to alarms, HVAC, external noises, traffic and so on will be treated the same way as the food sounds 701 from participant 104b and be ignored, as the AI-VAD engine 1002 will not flag the virtual microphone 302 at location 304c as a speech event and as a result will be ignored.

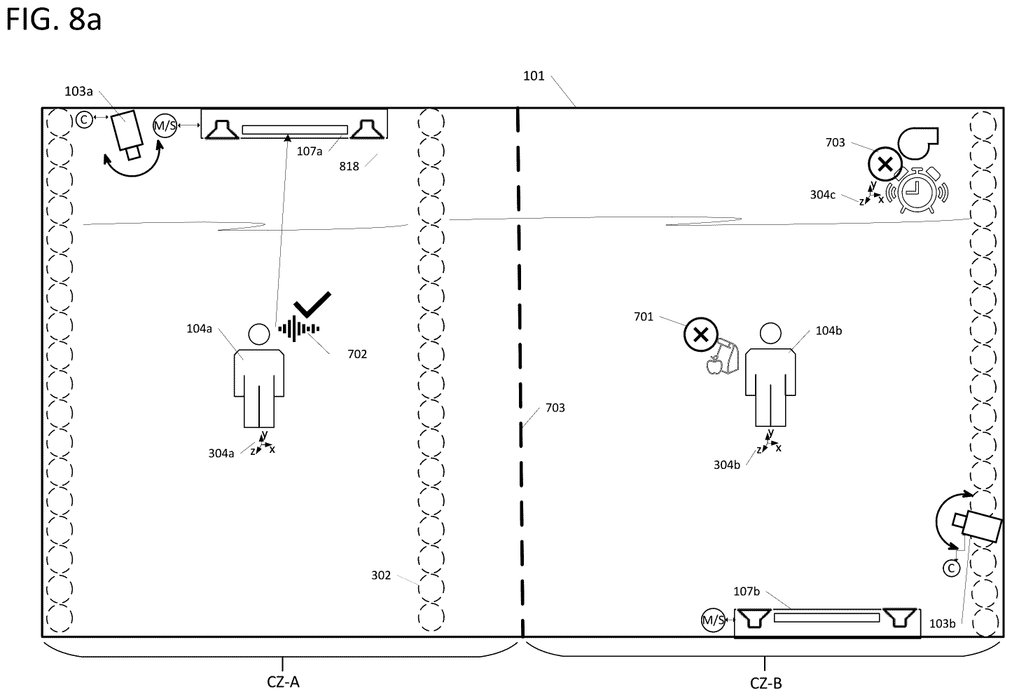

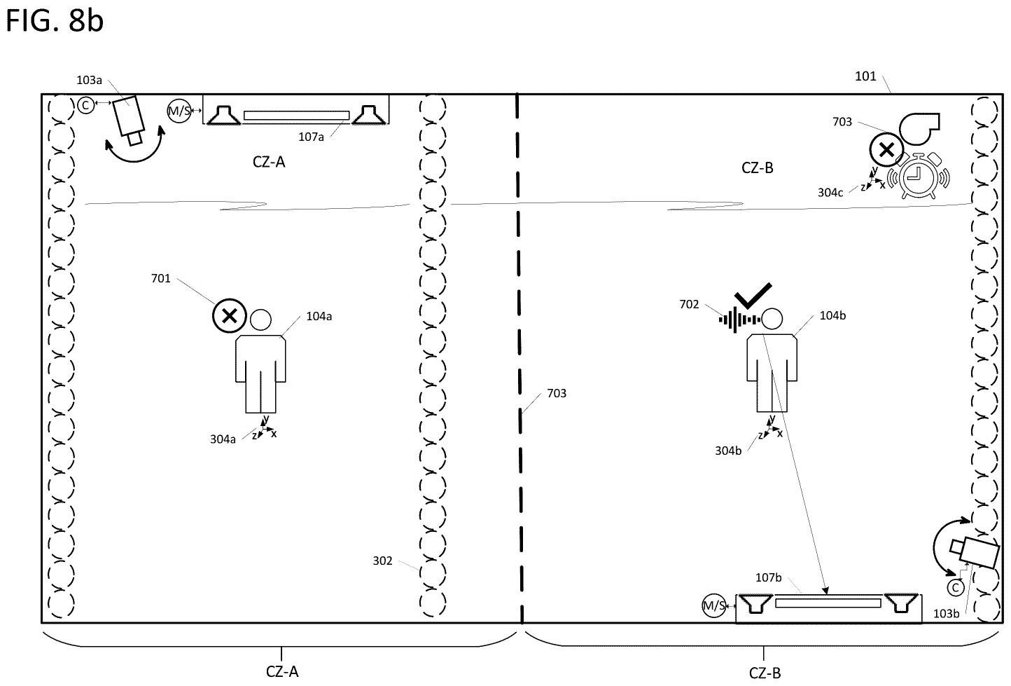

With reference now to FIGS. 8a-b, shown is a room 101 which contains two microphone/speaker bars 107a, 107b located in opposite corners and sides of the room 101. There are no specific placement constraints or requirements to support the disclosed invention for a multi-microphone/speaker bar 107a-b installation other than what would normally be typical to facilitate good audio performance in the room 101. The cameras 103a-b should also be placed to support the best video angles and focus quality that would normally be required in the room 101 to support UCC conference calls. In this scenario, the room 101 is equally divided up into two camera zones supported by camera 103a zone CZ-A and camera 103b zone CZ-B. The size and shape of the camera zones CZ-A, CZ-B are not a constraining requirement of the disclosed invention meaning that the Audio Processor 603 can be configured to support any client configured arrangement and configuration that would be typically used including custom video profiles and presets. Through system configuration the Audio Processor 603 can be configured to switch to and steer to any size, shape and number of camera zones that are required and should not be considered a limitation of the disclosed invention.

With reference to FIG. 8a participant 104a is speaking 702 at location 304a in the room. The Audio Processor 603 will sample a virtual microphone 302 at this location 304a and the AI-VAD engine 1002 will determine that a speech event 702 is occurring. This will trigger the camera director processor 602 to steer the appropriate camera 103a to the correct location 304a to the appropriate camera zone CZ-A in the room 101. Because participant 104b making sound the virtual microphone 302 at that location will pick this up, however since the sound is undesired 701 the AI-VAD engine 1002 will not validate this virtual microphone 302 at location 304b as a valid speech sound source 702. This virtual microphone 302 will be ignored at location 304b and the camera 103a will stay focused on participant 104a at location 304a.

FIG. 8b shows what happens when participant 104b starts to talk at location 304b. The virtual microphone 302 at location 304b will pick up the new speech signal 702 and as a result the AI-VAD processor will recognize the signal as a speech event 702. The AI-VAD engine 1002 will indicate to the Audio Processor 603 that this virtual microphone 302 contains a valid speech event, thus instructing the Camera Director processor 602 to switch to camera zone CZ-B since the virtual microphone 302 is contained in cameras zone CZ-B. This will cause camera 103b to take over the video to send to the remote participant 109 while it steers and focuses on participant 104b. Camera 103b will stay focused on participant 104b until a new speech event 702 is recognized at another virtual microphone 302 at which time the camera director processor 602 will switch to the correct camera zone CZ-A, CZ-B and steer and focus the correct camera 103a-b. It should be noted that the undesired sound 703 and the desired sound 702 are sharing the same camera zone CZ-B. The precise audio location information provided by the virtual microphone targeting processor 1001 will allow for the appropriate camera 103b to be steered and focused to the precise speaking 702 location 304b in conjunction with an extra camera 3^{rd} party processing software that identifies and focus on facial recognition technology. This would apply to any embodiment of the disclosed invention where 3rd party extra camera intelligent processing is utilized to focus in and direct the camera within a zone or preset.

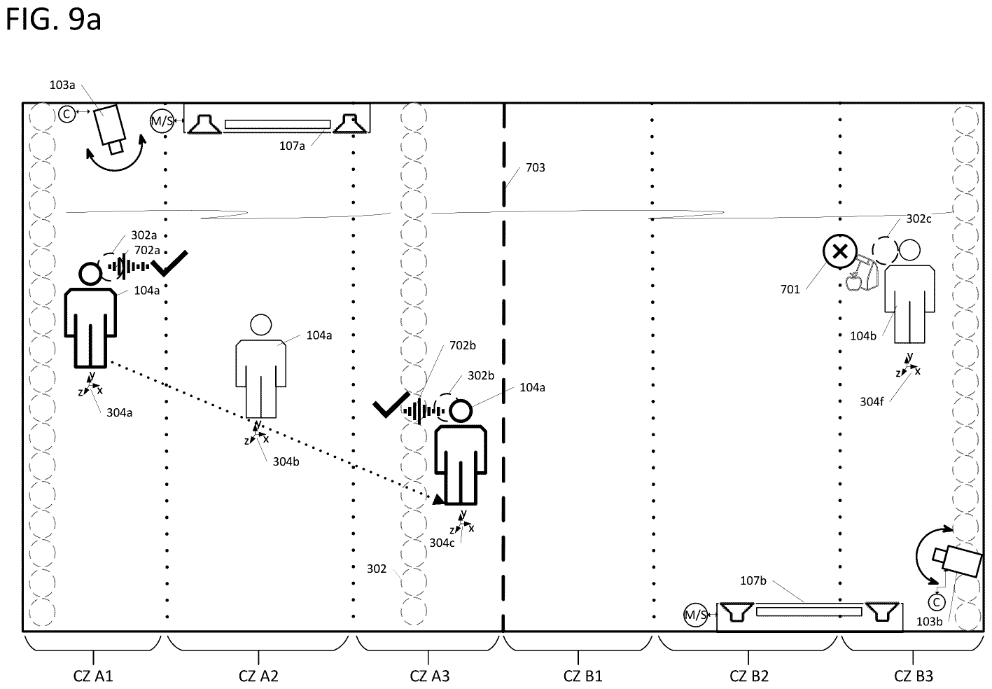

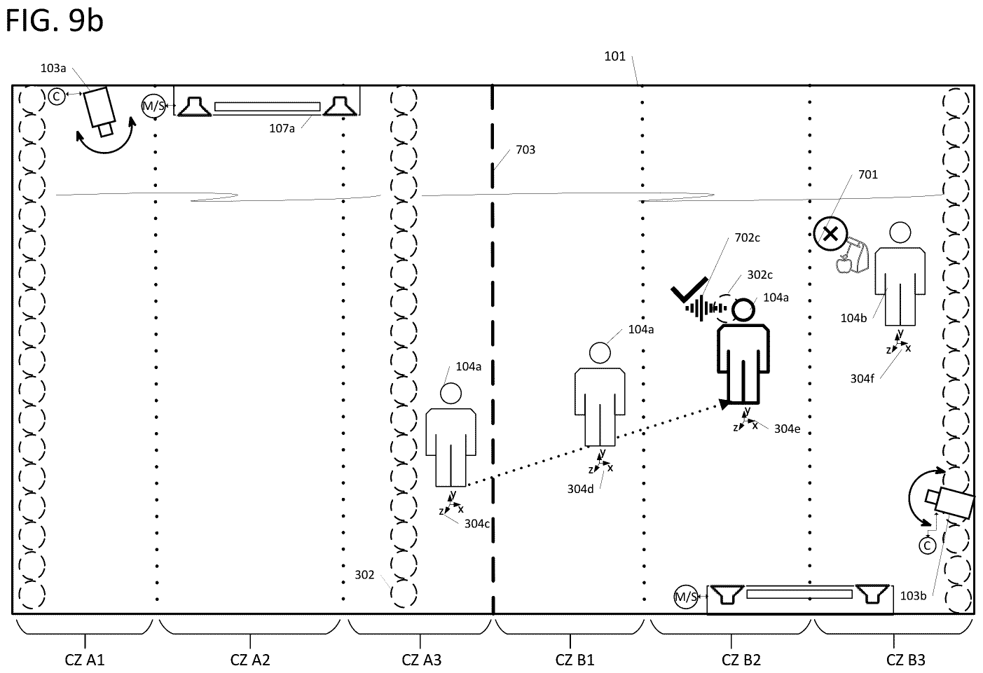

With reference now to FIGS. 9a-b, shown is a similar situation, however the room 101 is demarcated into 2 major camera zones CZ-A, CZ-B with sub-zones (presets) CZ A1, CZ A2, CZ A3, CZ B1, CZ B2 and CZ B3 respectively. The same principles and logic apply as described previously. The one difference is that since each major zone CZ-A is now configured to support 3 preset zones CZ A1, CZ A2, CZ A3, the camera 103a is required to move less and can allow for more specific steering options and settings that pertain to unique aspects for each sub-zone (preset). The number of sub-zones (presets) is not germane to the invention and the disclosed invention can support any number supported by hardware is considered to be in scope of the disclosed invention.

With continuing reference to FIG. 9a, the participant 104a walks through zones CZ A1, CZ A2 and CZ A3. The participant 104a will move through numerous virtual microphones 302 as he traverses the room 101. When the participant 104a speaks with speech events 702a, 702b such as at locations 302a, 302b. the appropriate virtual microphone 302 at each location 304a-c will pick up each sound event 702a, 702b, and the Audio Processor 603 will determine if a speech event 702 occurred using the AI-VAD Engine 1002. The Audio Processor 603 will steer the Camera Director processor 602 to the appropriate camera zone CZ A1 using camera 103a. After the speech event 702a is concluded the participant 104a proceeds to walk through to location 304c in the room 101. The participant 104a will traverse from camera zone CZ A1 to camera zone CZ A3 through camera zone CZ A2 and restart talking with a speech event 702b at virtual microphone 302b at location 304c. As the participant 104a traversed the room 101 they crossed camera zone CZ A2 without continuing or initiating a new speech event 702a. The Camera Director processor 602 having not received another valid speech event location to steer to and target will proceed to direct the camera 103a to follow the participant 104a throughout the CZ A2 zone and into the CZ A3 zone. The purpose of this is to maintain continuity of the video at the remote participants 109 end of the session. It would take a new valid speech event to redirect the Camera Director processor 602 to a new camera such as camera 103b and/or camera 103b presets. If the participant traversed again throughout camera 103a range of zones CA A1, CZ A2, CZ A3 without speaking and no new alternate location speech event occurred the camera director 602/camera 103a will continue to follow the participant 104a. Since participant 104a started a new speech event 702b the Audio Processor 603 will recognize this and keep the audio and video focused on participant 104a through the duration of the walking event to location 304c.

Participant 104b is eating food (undesired sound source) 701 which the virtual microphone 302c will-pickup at location 304f. However, because the Audio Processor 603 determines this is not a speech event and is to be ignored, the Camera Director Processor 602 is not instructed to move to this undesired sound source 701 location 304f in the room 101 thus preventing interruptions to the video feed for the remote participants 109 in the session.

With continuing reference to FIG. 9b, the participant 104a walks through zone CZ B1 to CZ B2. The Audio Processor 603 recognizes the speech event 702c at virtual microphone 302c at location 304e and directs the Camera Director Processor 602 to switch cameras to camera 103b. As the participant traverses the room 101, they pass through camera preset CZ B1 without speaking. As previously described camera 103b will track and follow participant 104b through zone CZ B1 unless a recognized speech event did occur during this time in another location in the room 101 at which point the Audio Processor 603 directs the Camera Director processor 602 to the new location at that time. This did not occur, so camera 103b tracks participant 104a to the new camera zone CZ B2. The participant 104a initiates a new speech event 702c at location 304e in camera zone CZ B2. The Audio Processor 603 recognizes this speech event and continues to target and focus the camera 103b on the participant 104a at location 304e in camera zone CZ B2. All the while participant 104b continued to generate undesired sounds 702 in camera zone CZ B3 which was determined to be an invalid speech event 701 by the Audio Processor 603, and no camera switching instructions were sent out by the Audio Processor 603 to the Camera Director Processor 602 maintaining a fluid sound and video experience for the remote participants 109.

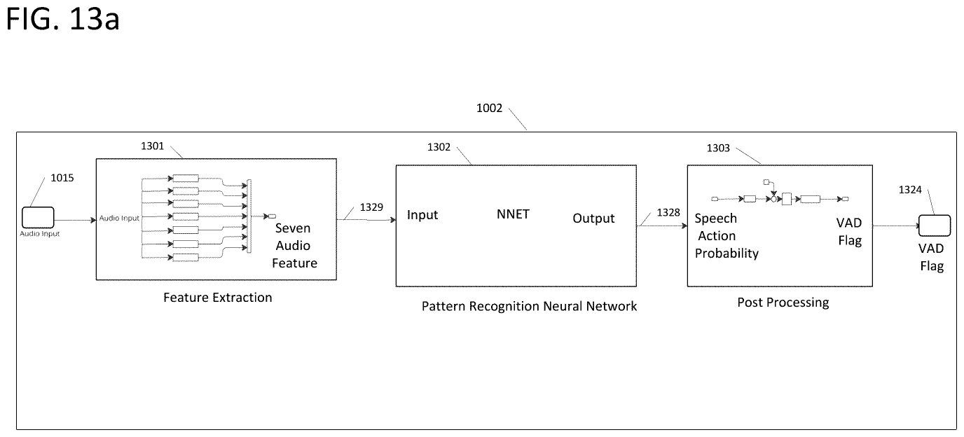

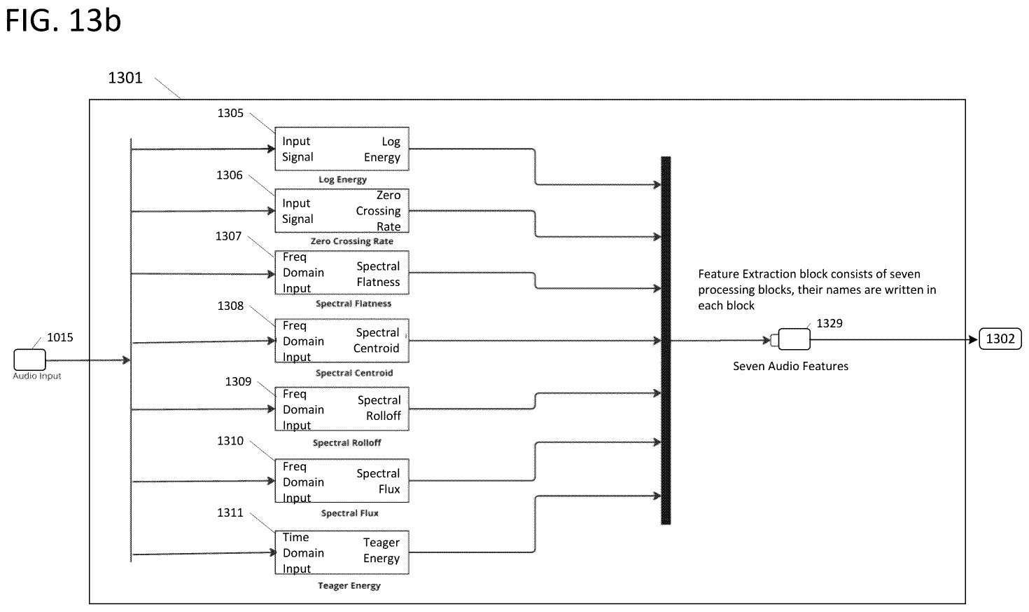

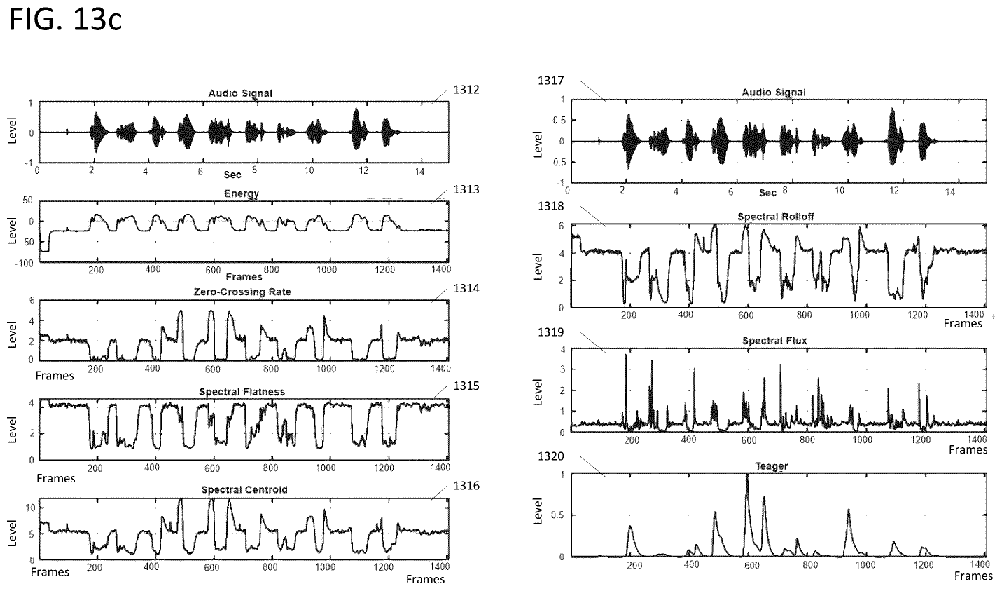

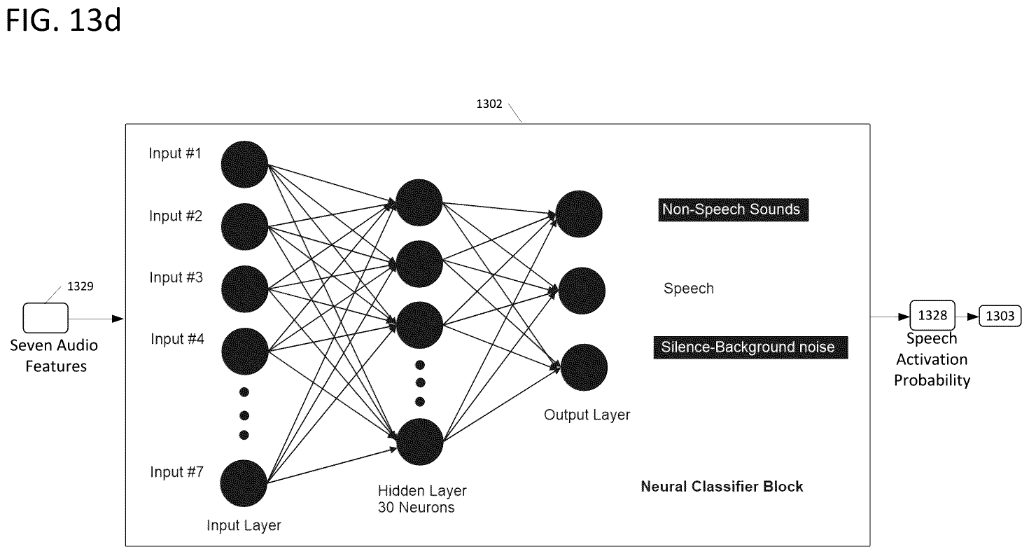

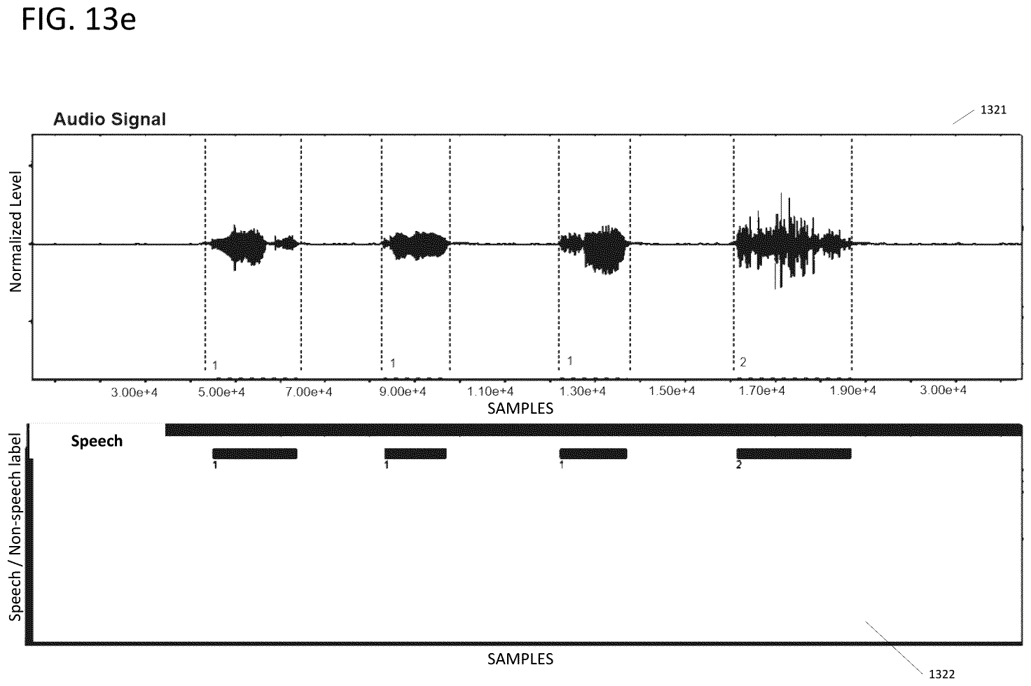

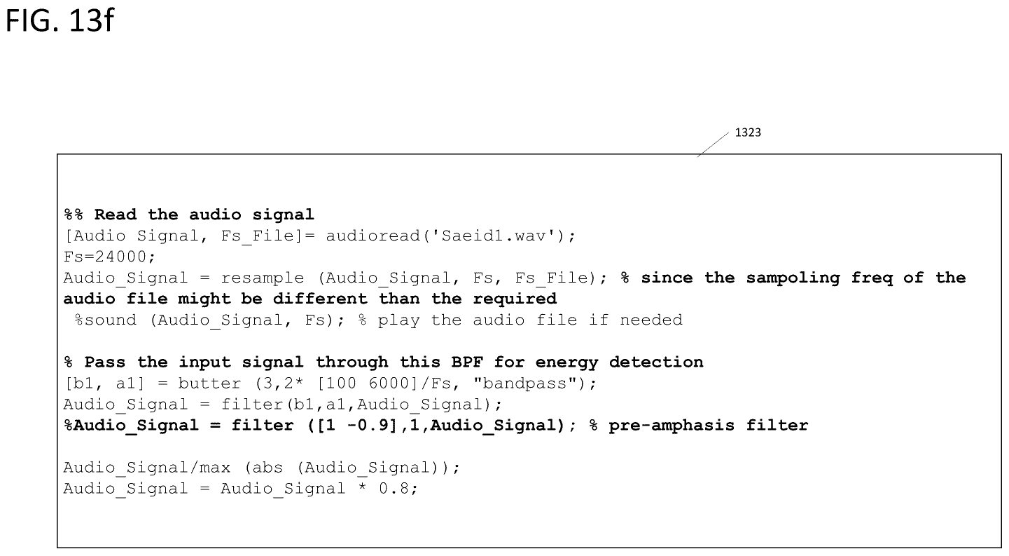

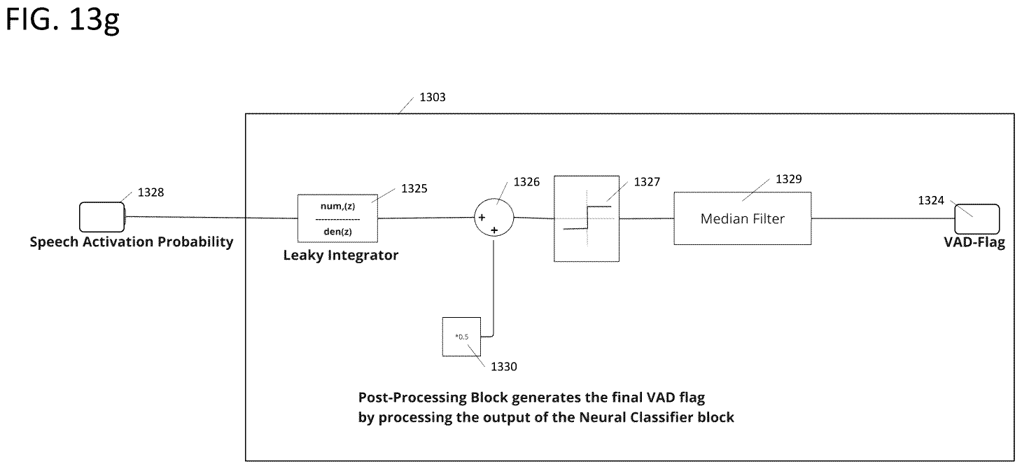

With reference now to FIG. 10a, this shows the primary processing components of the Audio Processor 603 in accordance with the disclosed invention. These components are the Audio Engine 1003 which performs echo cancellation, noise reduction and other optional audio processing on the raw microphone signals from microphone array 503 via path 1105 to provide individual microphone streams 1015 to the Targeting Processor 1001. The Audio Engine 1003 may optionally make use of the Voice Activity Detected (VAD) flag 1324 in FIG. 13a to improve certain aspects of audio processing. The Targeting Processor 1001 receives microphone signals from the Audio Engine 1003 via path 1004 and based on targeting criteria, generates a combined microphone stream 1015 focused on a virtual microphone 302 position 304 to send to the Voice Activity Detection processor 1002 and an external audio interface. The Targeting Processor 1001 may make use of the VAD flag 1324 from the Voice Activity Detection processor 1002 to improve targeting by limiting target selection changes to virtual microphones 302 where voice activity has been detected. The Voice Activity Detection processor 1002 calls a Voice Activity Detection engine 1002 reference in more detail in FIG. 13a. AI-VAD Engine 1002 which utilizes Configuration Parameters and Coefficients 1013 and receives a combined microphone stream 1015 from the Targeting Processor 1001 and outputs the location 304 information and a Voice Activity Detected (VAD) flag 1324 to: the Audio Engine 1003; Targeting Processor 1001; and external Camera Switching/Director Systems 601, 602, 605 via path 1008. The Audio Engine 1003 and Targeting Processor 1001 provide output signals to speaker array 502 via path 1012.

FIG. 10b, shows an alternate implementation of the primary processing system where the Targeting Processor 1001 incorporates an Integrated VAD Engine 1002 forming a combined Targeting Processor with VAD engine 1005. The integrated component also utilizes Configuration Parameters and Coefficients 1013. As previously described, the integrated Targeting and VAD processing engine 1005 receives microphone signals 1004 from the Audio Engine 1003 and utilizing the Configuration Parameters and Coefficients 1013, generates the targeted virtual microphone 302 location 304 and VAD flag/indicator 1324 for use by the Audio Engine 1003, Targeting Processor 1001, and external Camera Switching/Director Systems 601, 602, 605.

With reference now to FIG. 11a, shown is an exemplary signal flow within the Target Processor (bubble processing) unit 1001. This example preferably monitors 8192 bubbles, or e.g., hundreds, thousands, or tens of thousands virtual microphone bubbles 302 simultaneously (e.g., to achieve full or near full room coverage). The sound from each microphone element 504 is sampled at the same time as the other elements within the microphone array 503 and, preferably, at a fixed rate of 12 kHz. Each sample is passed to a microphone element processor 1101 illustrated in FIG. 11b. The microphone element processor 1101 preferably conditions and aligns the signals in time and weights the amplitude of each sample so they can be passed on to the summing node 1110.

The signal components 1107 from the microphone's element processor 1101 are summed at node 1110 to provide the combined microphone array 503 signal for each of the, e.g., 8192, virtual microphone bubbles 302. Each virtual microphone 302 signal is preferably converted into a power signal at node 1111 by squaring the signal samples. The power signals are then preferably summed over a given time window by the 8192 accumulators at node 1112. The sums represent the signal energy over that time period.

The processing gain for each bubble 302 is preferably calculated at node 1113 by dividing the energy of each bubble by the energy of an ideal unfocused signal 1119. The unfocused signal energy is preferably calculated by summing 1109 the energies of the unfocused signals from each microphone element 1105 over the given time window, weighted by the maximum ratio combining weight squared. This is the energy that we would expect if all of the signals were uncorrelated. The processing gain 1113 is then preferably calculated for each bubble 302 by dividing the microphone array signal energy by the unfocused signal energy from node 1109.

With continuing reference to FIG. 11a, processing gain is achieved because signals from a common sound source all experience the same delay before being combined, which results in those signals being added up coherently, meaning that their amplitudes add up. If twelve (12) equal amplitude and time aligned direct signals 1105 are combined the resulting signal will have an amplitude 12× higher, or a power level 144× higher. Signals from different sources and signals from the same source with significantly different delays as the signals from reverb and noise do not add up coherently and do not experience the same gain. In the extremes, the signals are completely uncorrelated and will add up orthogonally. If twelve (12) equal amplitude orthogonal signals are added up, the signal will have roughly 12× the power of the original signal or a 3.4× increase in amplitude (measured as rms). The difference between the 12× gain of the direct signal 1105 and the 3.4× gain of the reverb and noise signals is the net processing gain (3.4 or 11 dB) of the microphone array 503 when it is focused on the sound source 104. This makes the signal sound as if the microphone 504 has moved 3.4× closer to the sound source. This example uses a twelve (12) microphone array 503 but it could be extended to an arbitrary number (N) resulting in a maximum possible processing gain of sqrt (N) or 10 log (N) dB.

The target processor/bubble processor system 1001 preferably simultaneously focuses the microphone array 503 on the, e.g., 8192, virtual microphone points 302 in 3D space using the method described above. The energy level of a short burst of sound signal (50-100 ms) is measured at each of the, e.g., 8192, virtual microphone bubble 302 points and compared to the energy level that would be expected if the signals combined orthogonally. This gives us the processing gain 1113 at each point. The virtual microphone bubble 302 that is closest to the sound source 104 should experience the highest processing gain and be represented as a peak in the output. Once that is determined, the location is known.

With continuing reference to FIG. 11a, node 1117 preferably searches through the output of the processing gain unit 1113 and/or other data accumulated and/or gathered (e.g., nodes 1110, 1111, 1112, 1114, 1115, 1116, 1119, 1120, 1121, 1123,) for the bubble with the highest processing gain functions. The (x, y, z) location and other source signal attributes 1102 of the virtual microphone 302 corresponding to that bubble can then be determined by looking up the index in the original configuration to determine the exact location of the sound source 104. The parameters 1102 may be communicated to various electronic devices to focus them to the identified sound source position. After deriving the location of the sound source 104, focusing the microphone array 503 on that sound source 104 can be accomplished after achieving the gain. The Targeting (Bubble) Processor 1001 is designed to find the sound source 104 quickly enough so that the microphone array 503 can be focused while the sound source 104 is active which can be a very short window of opportunity. The target (bubble) processor system 1001 preferably finds new sound sources in less than 100 ms. Once found, the microphone array 503 focuses on that location 304 to pick up the sound source signal 104 and the system 1000 reports the location 304 of the sound through the Identify Source Signal Position 1117 to other internal processes and to the host audio processor 603 so that it can implement sound sourced location-based applications. Preferably, this is the purpose of the bubble processor 1001. Since each bubble 302 will have a unique propagation delay to the microphones 504, a dynamic microphone bubble 302 to microphone array 503 pattern is developed. This pattern is unique to that dynamic microphone bubble location 304. This results in a propagation delay pattern to processing-gain matrix 1115 that is determined in FIGS. 11a and 11b. Once the max processing gain is determined from the, e.g., 8192, dynamic microphone bubbles 302, the delay pattern will determine the unique dynamic microphone bubble locations. The predefined bubble locations are calculated based on room size dimensions and the required spacing to resolve individual bubbles 302, which is frequency dependent.

The Mic Element Processor 1101, shown in FIG. 11b, is preferably the first process used to focus the microphone array 107 on a particular bubble 302. Individual signals from each microphone 504 are passed to a Precondition process 11065. The Precondition 11065 process filters off low frequency and high frequency components of the signal resulting in an operating bandwidth of 200 Hz to 6000 Hz.

With reference again to FIG. 11b, a microphone (x) delay line 11066 preferably stores the pre-conditioned sample plus a finite number of previously pre-conditioned samples from that microphone element 504. During initialization, the fixed virtual microphone 302 positions and the calculated microphone element 504 positions are known. For each microphone element 504, the system preferably calculates the distance to each virtual microphone 302 then computes the added delay 11063 needed for each virtual microphone and preferably writes it to a delay look up table 11063. The system also computes the maximal ratio combining weight for each virtual microphone 302 (the virtual microphone bubble specific weight) and stores that in the weight lookup table 11064. See, for example, the '987 patent for a description of how to calculate the added delay 11063 and the maximal combining weight for each virtual microphone 302.

A counter 11061, preferably more than 8192 spatial samples (locations), counts bubble positions, e.g., from 0 to 8191, and sends this to the index of the two look up tables 11063 and 11064. The output of the bubble delay lookup table 11063 is preferably used to choose that tap of the delay line 11066 with the corresponding delay for that bubble. That sample is then preferably multiplied 11067 by the virtual microphone bubble weight 11064 read from the weight lookup table 11064. For each audio frame input to the microphone element processor 1101, 8192 spatial samples (locations power) are output 11068, each corresponding to the signal component for a particular virtual microphone bubble 302 in relation to that microphone element 1101.

With continuing reference to FIG. 11b, the second method by which the array may be used to improve the direct signal strength is by applying a specific virtual microphone bubble weight to the output of each microphone element 1101. Because the microphones 504 are not co-located in the exact same location, the direct sound 201 will not arrive at the microphones 703 with equal amplitude, as shown in FIG. 2. The amplitude drops as 1/r 203 and the distance (r) is different for each combination of microphone 504 and virtual microphone bubble 302. This creates a problem as mixing weaker sound source signals 202 into the output at the same level as stronger sound source signals 201 can actually introduce more noise and reverb (reflected signals) 202 into the system 1001 than not. Maximal Ratio Combining is the preferable way of combining signals 1110. Simply put, each signal in the combination should be weighted 11064 proportionally by the amplitude of the signal component to result in the highest signal to noise level. Since the distance that each direct path 201 travels from each bubble 302 position 304 to each microphone 504 is known, and since the 1/r law 203 is also known, this can be used to calculate the optimum weighting 11064 for each microphone 504 at each of the, e.g., 8192, virtual microphone points 302.

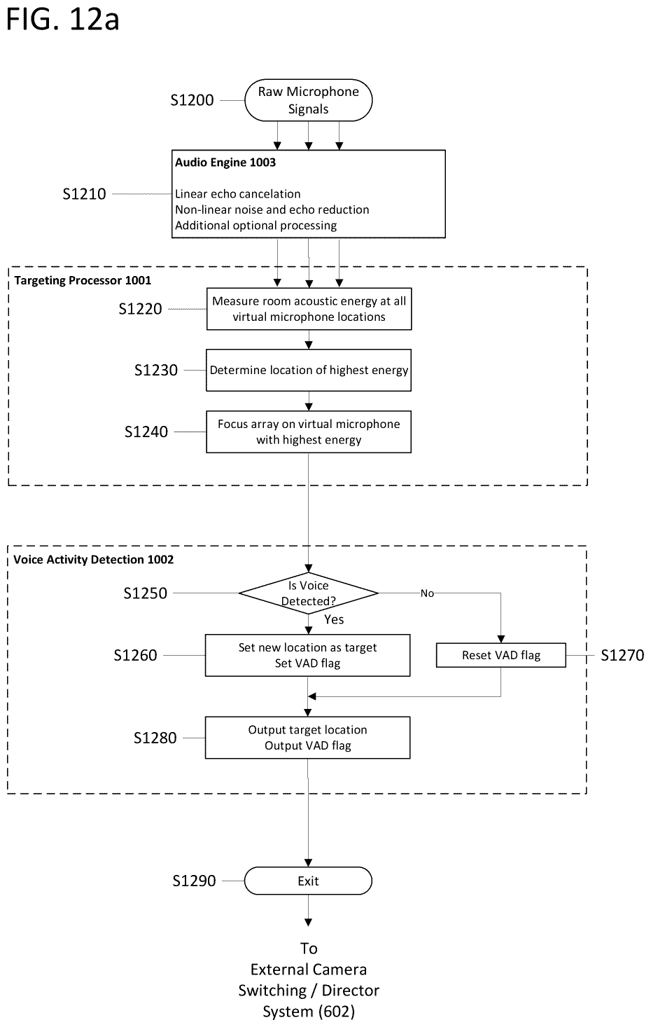

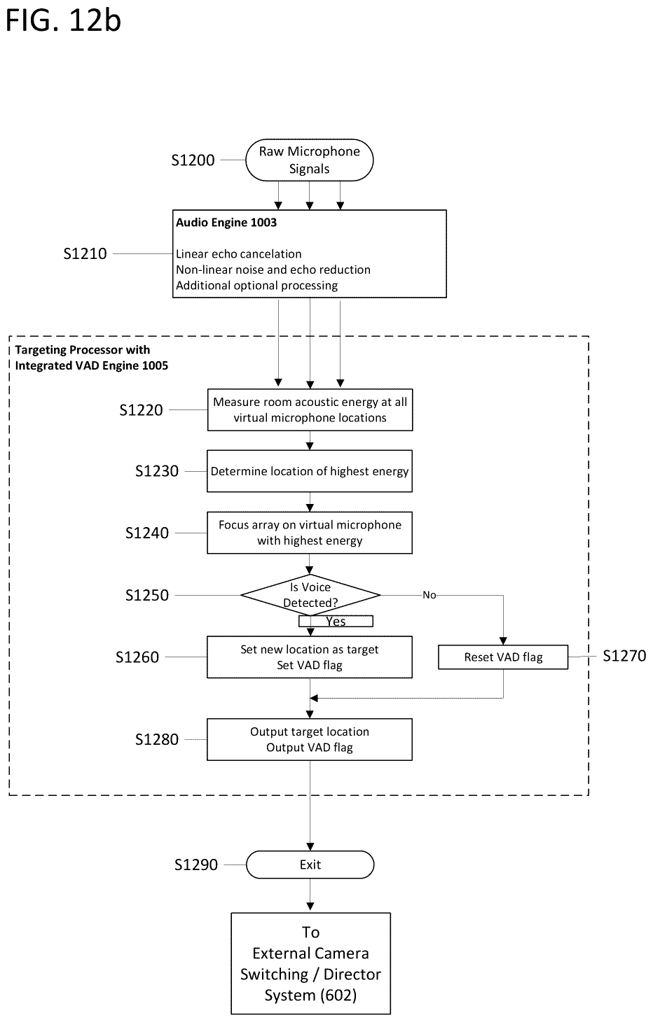

With reference to FIG. 12a, shown is the system logic flow for the system outlined in FIG. 10a. Step S1200 starts by sending Raw Microphone Signals 1105 to the Audio Engine 1003 where linear echo cancelation, non-linear noise and echo reduction, and additional, optional processing are performed in step S1210. In step S1220 the Targeting Processor 1001 with performs the next step of measuring the acoustic energy at all virtual microphone 302 locations 304 configured for the room 101. Virtual microphone 302 locations are considered potential targets, and the best candidate is selected as the new target in step S1230 with the microphone array 503 focus being changed to the new location 304 in step S1240. The output from the Targeting Processor 1001 is the location information and a combined microphone stream 1015 which is focused at that location 304. The Voice Activity Detection processor 1002 performs the next step S1250 of processing the combined microphone stream using an Artificial Intelligence Voice Activity Detector (AI-VAD) 1002 engine. If voice activity 702 is detected by the algorithm, step S1260 sets the new location 304 as the target and the VAD flag 1324 is set indicating voice content 702 in the microphone stream 1015. If voice activity 702 is not detected, the new location 304 is ignored, and the VAD flag 1324 is reset/cleared in step S1270. When the location 304 information is requested for external camera 103 switching/director systems, the current target location and VAD flag 1325 are sent in step S1280. The VAD flag which indicates the speech or non-speech interval will be finally reported to the external camera switching algorithm in step S1290.

With reference to FIG. 12b, shown is an alternate implementation outlined in FIG. 10b of the system logic flow where the AI-VAD engine 1002 is integrated with the Targeting Processor forming the Targeting and VAD processor engine 1005. This implementation includes the same essential steps but steps S1250, S1260, S1270, S1280 are more tightly integrated into the targeting processor 1001 to better optimize flow and improve targeting response time for quicker, more reliable array 503 focusing.

With reference to FIG. 13a AI-VAD Engine, shown the Voice activity detection (AI-VAD) Engine 1002 is based on the state-of-the-art machine learning techniques (ML/AI) for speech processing 702. The AI-VAD processing module 1002 can be incorporated in the Audio Processor 603, standalone or in other 3rd party solutions including cloud-based systems, which takes the pre-processed audio signal 1015 from the Audio Processor 603 and provides an output VAD flag 1324 when the presence of voice 702 is detected.

With continuing reference to FIG. 13a AI-VAD Engine details, the AI-VAD engine 1002 consists of three main blocks: the feature extraction processor 1301, the neural classifier processor 1302, and the post-processing processor 1303. The incoming audio signal 1015 is divided into 20 msec frames with 10 msecs overlap, any other frame length normally between 5 msec to 50 msec can also be considered. The overlap can also change from 25% to 75% within the present invention.

With reference to FIG. 13b Feature Extraction, shown but not limited to are three time-domain features Log energy 1305, Zero Crossing Rate 1306, Teager Energy 1311, and four frequency domain features Spectral Flatness 1307, Spectral Centroid 1308, Spectral Rolloff 1309 and Spectral Flux 1310 which are extracted for each frame, making seven features in total. Their definitions are known in the audio processing community and are further described below. However, this embodiment is not limited to these number of features; any other relevant audio feature can also be considered for the AI-VAD engine 1002. To extract the features the audio frame is first multiplied by a Hamming window. Applying Hamming (or similar windowing like Hanning) is well known in audio and speech processing industry before any secondary processing).

The Log energy 1305 feature is the logarithm of the energy of the audio signal 1015 over one frame. Energy is defined as the sum of the squared values of audio samples. Then the logarithm of this energy is calculated and used as the energy feature. This feature discriminates between a silent interval and a non-silent interval. See equation (1).

$$E = 10 {log}_{10} \{ {\sum }_{n} {x}^{2} ( n ) \} \qquad ( 1 )$$

The second feature is the zero-crossing rate 1306 over one frame. The zero-crossing rate 1306 of the voiced part 702 of the speech is lower than its unvoiced part. The flat background noise has the highest zero-crossing rate 1306. See equations (2) and (3).

$$ZCR = \frac{1}{2} {\sum }_{n} \vert sgn \{ x ( n ) \} - sgn \{ x ( n - 1 ) \} \vert \qquad ( 2 )$$

$$sgn \{ x ( n ) \} = \{ \begin{matrix}+ 1 , & x ( n ) \geq 0 \\ - 1 , & x ( n ) < 0\end{matrix} \qquad ( 3 )$$

For frequency domain features (Spectral flatness 1307, spectral centroid 1308, spectral roll-off 1309 and spectral flux 1310) the fast Fourier transform (FFT) of every frame is first calculated. Then these four frequency domain features are calculated based on the following Discrete Fourier transform (DFT) equation:

$$X ( k ) = DFT \{ x ( n ) \} = {\sum }_{n = 0}^{N - 1} x ( n ) {e}^{- jk 2 π n / N} \qquad ( 4 )$$

$$k = 0 , 1 , … , N - 1$$

Spectral entropy 1307 has low values for voiced parts 702, and it shows a higher value for unvoiced part of the speech 702 and even higher for flat noise intervals. See equations (5) and (6).

$$p ( i ) = \frac{{\vert X ( i ) \vert}^{2}}{{\sum }_{k = 1}^{\frac{N}{2} - 1} {\vert X ( k ) \vert}^{2}} \qquad ( 5 )$$

$$Spectral Entropy = - {\sum }_{i = 1}^{\frac{N}{2} - 1} p ( i ) log \{ p ( i ) \} \qquad ( 6 )$$

The spectral centroid 1307 is used to identify voice and unvoiced regions. The spectral centroid 1307 is low in the speech regions 702 and high for non-speech regions 701. See equation (7).

$$Spectral Centroid = \frac{{\sum }_{k = 1}^{\frac{N}{2} - 1} f ( k ) \vert X ( k ) \vert}{{\sum }_{k = 1}^{\frac{N}{2} - 1} \vert X ( k ) \vert} \qquad ( 7 )$$

$$f ( k ) = frequency at bin k$$

The spectral roll-off 1309 is defined as the frequency at which 85% of the spectrum magnitude is concentrated. Roll-off 1309 is a measure of the spectral shape and it has higher values in the higher frequency regions than in the low frequency regions and therefore it can be used in voice activity detection with lower values for the voiced parts 702 and higher for the unvoiced part. See equation (8).

$$Spectral Rolloff = arg {min}_{f} ( {\sum }_{k = 1}^{f} \vert X ( k ) \vert \geq 0.85 {\sum }_{k = 1}^{\frac{N}{2} - 1} \vert X ( k ) \vert ) \qquad ( 8 )$$

The spectral flux 1310 indicates the variations between spectral components of the adjacent frames and it can distinguish between signals whose spectrum changes slowly from signals whose spectrum changes quickly. See equation (9).

$$Spectral Flux = {\sum }_{k = 1}^{\frac{N}{2} - 1} {\{ \vert {X}_{m} ( k ) \vert - \vert {X}_{m - 1} ( k ) \vert \}}^{2} \qquad ( 9 )$$

where Xₘ(k) and Xₘ₋₁(k) are the normalized magnitude of the DFT of the m-th and (m−1)-th frames, respectively.

The Teager Energy Operator (TEO) 1311 is often used for transient change detection in a given signal 1015 and it is the feature used for transient and spiky noise detection in our application such as computer keyboard typing, sudden object movement and similar non-speech sounds 701. These sounds are common in audio conference room's 101. For the TEO feature 1311 we first apply the following operation to every sample of the frame.

$$TEO ( n ) = {x}^{2} ( n ) - x ( n + 1 ) x ( n - 1 ) \qquad ( 10 )$$

Then we take the maximum value of the absolute value of the TEO signal 1311 over one frame. See equations (10), (11).

$$TEO Feature = [ max \{ \vert TEO ( n ) \vert \} ] \qquad ( 11 )$$

Each of the above features is passed through a leaky integrator 1325 given below with the parameter between 0.3 to 0.9 to further smooth the features. See equation (12).

$${Feature}_{History} ( m ) = γ \cdot {Feature}_{History} ( m - 1 ) + ( 1 - γ ) \cdot {Feature}_{Inst value} \qquad ( 12 )$$

Feature_{Inst value}=The instantaneous value of the feature at the current frame
Feature_{History}(m)=The smoothed value of the feature reported to the neural engine 1302 at the current frame m
Feature History (m−1)=The smoothed value of the feature reported to the neural engine 1302 at the previous frame m−1
γ=Leaky parameter in the range of 0.3 to 0.9
   All features are scaled to fall in the same dynamic range for neural engine training 1302.

With reference to FIG. 13c, shown is a sample of audio clip graphs along with extracted features are shown. Graph 1312 shows a sample speech recording along with its energy feature 1313, zero crossing rate feature 1314, spectral flatness feature 1314, and spectral centroid feature 1316. Graph 1317 shows the same speech recording along with spectral roll-off feature 1318, spectral flux 1319 and Teager energy feature 1320.

With reference to FIG. 13d, shown is a neural classifier 1302 which is a multi-layer perceptron (MLP) known to the industry with one hidden layer with 30 neurons. Although, this embodiment is not limited to this type of network, and any general neural network with a larger number of neurons or additional layers can be similarly used and is not limited here. The seven features 1329 extracted in the previous stage FIG. 13b are fed into the input of this neural classifier 1302. Unlike many similar AI-VAD systems where their neural network engine has only two outputs, neural engine 1302 of the present invention has three outputs and it can distinguish between speech 702, non-speech sounds 701, and silence/background noise. Considering additional non-speech sounds 702 helps to better train the model and to better detect speech 702 activities versus non-speech sounds 701.

The neural engine 1302 is first trained with different words and phrases 702 spoken by different talkers and also with different types of non-speech sounds 701 like the sound of the computer keyboard, clapping, moving objects, etc. and the background noise or their combinations.

With reference to FIG. 13e Labeling Procedure for Training the Neural Engine, shown is the neural engine 1302 is first trained with different words and phrases 702 spoken by different talkers and also with different types of non-speech 701 sounds like the sound of the computer keyboard, clapping, moving objects, etc. and the background noise or their combinations 1321. Every speech sound 702 (labeled 1) and non-speech sound 701 (labeled 2) interval 1322 need to be labelled prior to training. This may be accomplished using which is using Signal Labeler App from MATLAB® or any other similar program capable of labeling speech and non-speech sounds. The selected parts within dashes specify the speech and non-speech parts of the audio recording labeled separately prior to training. Then these labeled parts are fed to the neural classifier 1302 along with seven audio features 1305-1311 to train the neural engine. Our AI-VAD training procedure follows the well-known supervised learning procedure in the industry during which the extracted features are fed to the AI engine and the presence or absence of speech is known and is given to the AI engine for training. FIG. 13e shows this training procedure. During speech intervals 1321, the VAD flag is set to 1 as shown in 1322. This flag is otherwise as shown in 1322.

With reference to FIG. 13f Matlab Training Model 1323 shows a part of a MATLAB® script that may be used for processing and training the model 1002. The script may be used off-line using a processed audio signal of a tape loop output. The training can be done through any AI/ML software package or similar tools. For example, a Matlab/Simulink Deep Learning toolbox is shown in FIG. 13f. Multiple audio clips were used for training. Then proprietary Matlab scripts 1323 were written to train the data.

With reference to FIG. 13g Post Processing, shown is the output of the Neural engine 1302 gives the probability of speech presence 1328 where it should be processed further in the post-processing processor 1303 to generate the final VAD flag 1324 and reported as either one (Speech detected) 702 or zero (no Speech detected) 701. In the post-processing processor 1303, the output of the Neural engine 1302 enters the leaky integrator 1325 and a median filter 1329 to produce the output VAD flag 1324. Another median filter 1329 can also be considered in front of the leaky integrator 1325 as a part of this embodiment to improve the AI-VAD engine 1002 performance. Both the leaky integrator 1325 and the median filter 1329 are known in the audio processing community and are used to reduce the false detection rate. A constant value 1330 (e.g., 0.5) is added by 1326 to the output of the leaky integrator 1325 to provide an appropriate signal for the hard-slicer 1327.

The probability of the speech presence 1328 out of the neural engine 1302 is a number between 0 and 1 which is expected to be closer to one for speech intervals 702 and closer to zero for non-speech intervals. However, occasional anomalies may occur due to the probabilistic nature of the prediction. To remove these anomalies, the above two stage post processing composed of smoothing 1325 and median filtering 1329 is utilized in the post-processing processor 1303. The leaky integrator 1325 is used for smoothing and its output enters a hard slider 1327 to convert the probabilistic number into either one or zero. Then the median filter 1329 removes any sudden false one or zero in between speech intervals 702 or non-speech intervals 701 and generates the final VAD flag 1324.

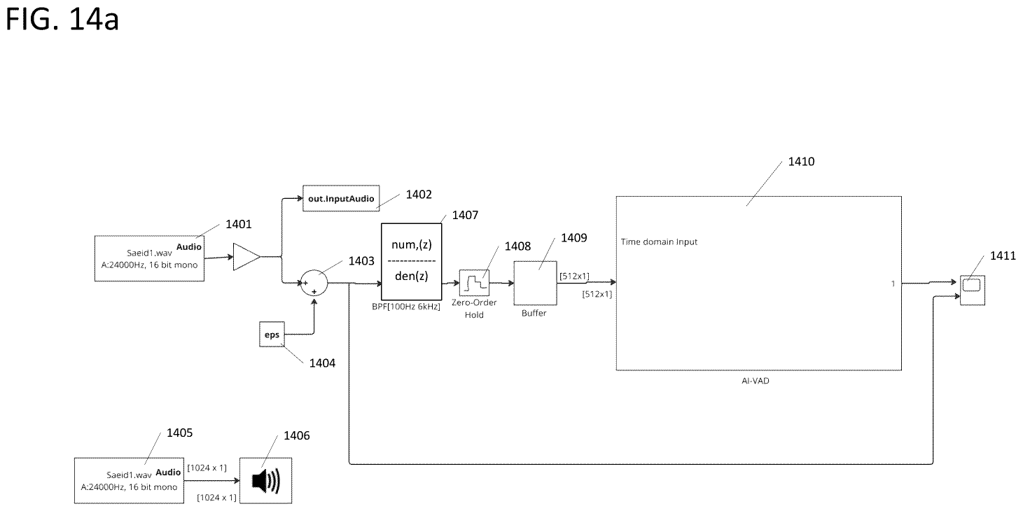

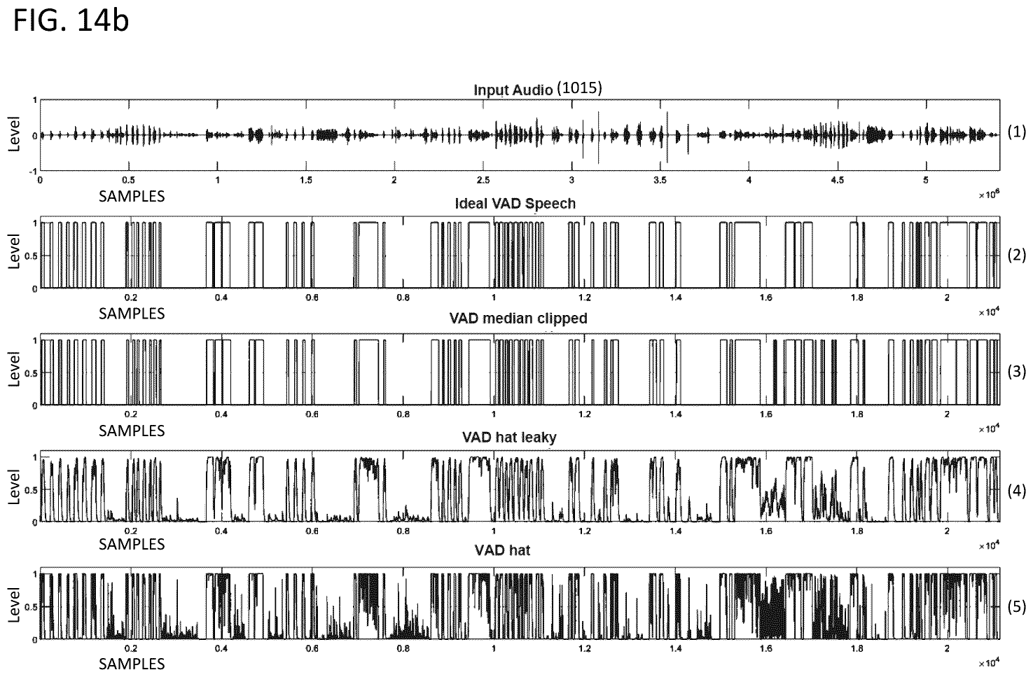

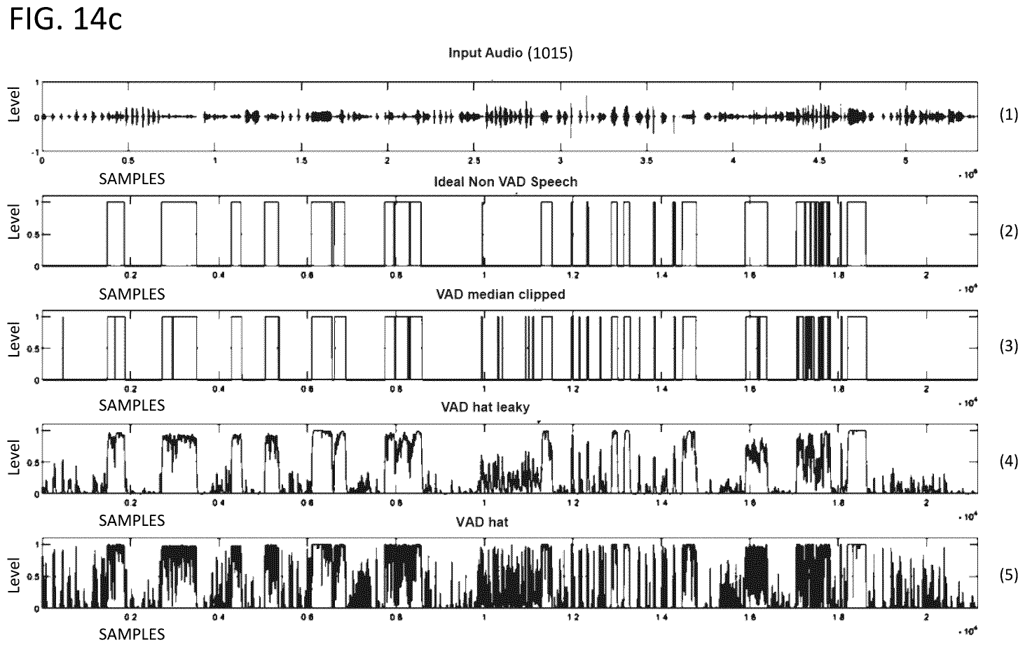

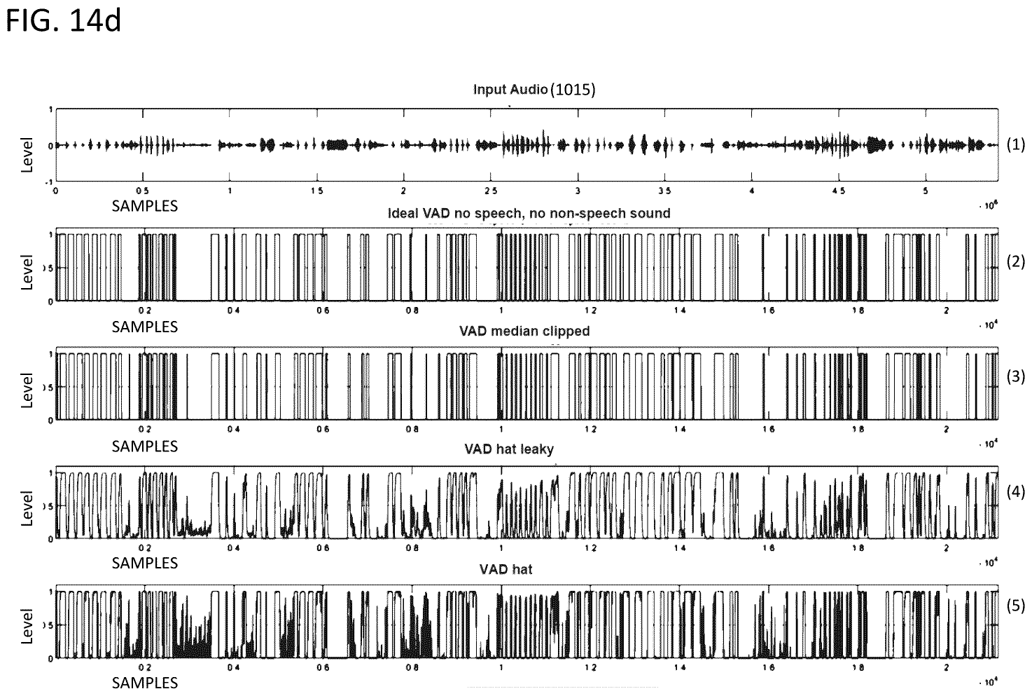

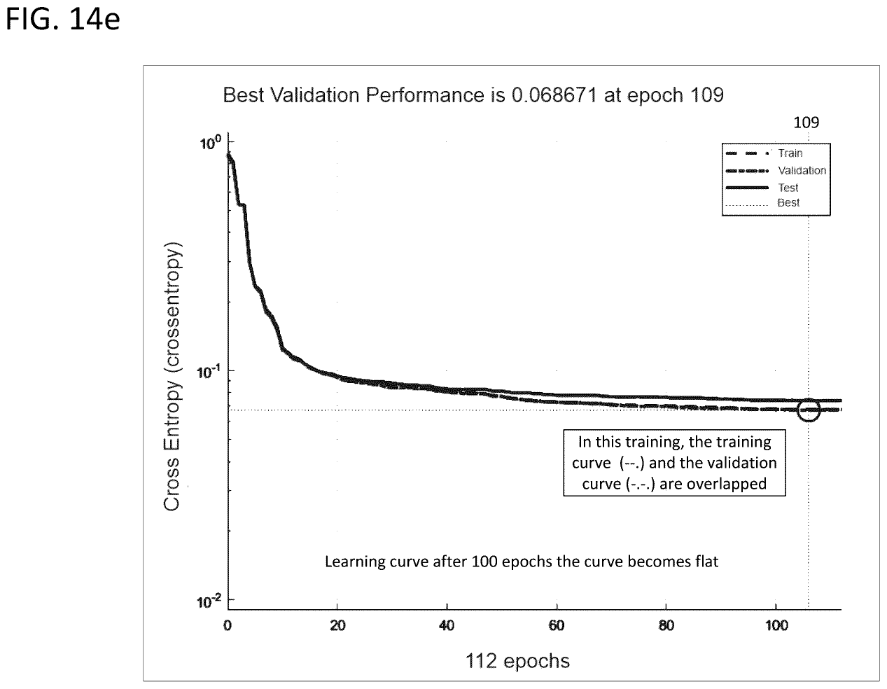

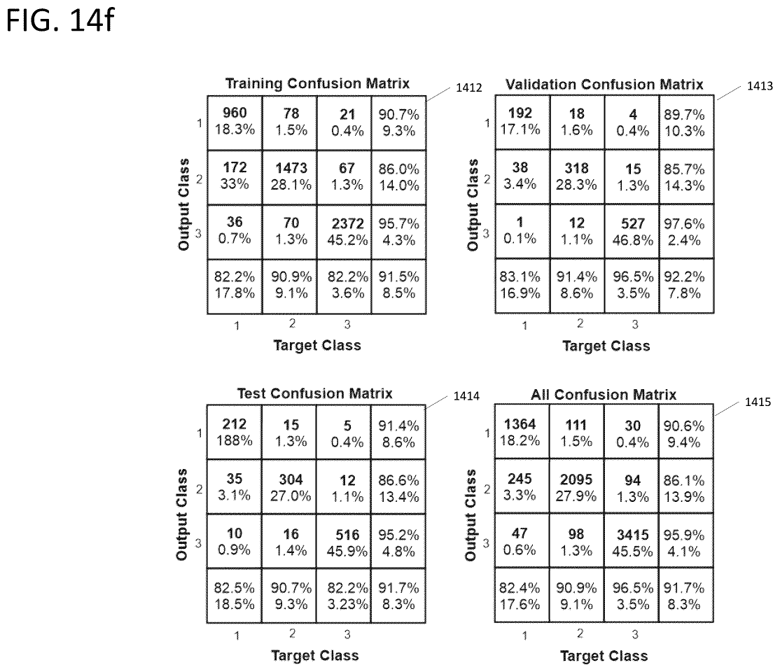

With reference to FIG. 14a Training Model Structure, shown is the trained network and the completed AI-VAD engine 1002 module are tested in real-time in a MATLAB® simulation environment to ensure the correctness of the results. The recorded audio file 1401 (e.g., Saed1.wav, A: 24000 Hz, 16 bit mono) is read and pre-processed by initial bandpass filter (100 Hz-6000 Hz) 1407 and sampled and buffered through zero-order hold block 1408 and the buffer 1409 prior to trained AI-VAD model 1410. Block 1407 passes the audio signal through a bandpass filter which extracts the useful bandwidth of the signal. Block 1408 takes repetitive samples of the signal and saves them in the data storage buffer 1409 and constructs one frame of the audio for further processing. The same audio file is also played through 1405 and the speaker 1406 and can be heard during training or inference to observe the status of the VAD flag during speech or non-speech sounds. The same audio file can also be saved by 1402 for offline processing if required Processing steps DC Offset adjust 1403 and summation 1404 are used for adding offset to the audio signal for real-time visual inspection of the VAD flag together the with audio signal through the device display block 1411

With reference to FIG. 14b Audio Speech, 14c non-Speech audio, 14d Background noise, shows the results of the trained AI-VAD engine 1002 for the speech detection 702, non-speech sounds 701 detection and silence interval detection, respectively.

With reference to FIG. 14b Audio Speech, shows the audio input 1015 is shown at the top figure (subplot(1)). The output of the neural engine 1328 which is the input to the post-processing processor is shown in the lowest figure (subplot(5)). The output of the leaky integrator 1325 is shown in subplot(4). The output of the median filter 1329 is shown in subplot(3) which shows the estimated speech intervals and can be compared with the ideal speech interval 702 shown in subplot(2).

With reference to FIG. 14c Non-Speech audio, shows exactly the same outputs as in FIG. 14b Audio Speech, but for non-speech sounds 701 output of the AI-VAD module 1002. This output is not reported as an output flag, but it can be if needed for other purposes.

With reference to FIG. 14d Background noise, shows exactly the same outputs as in FIG. 14b Audio Speech, but for the silence periods or low background noise 701 output of the AI-VAD engine 1002. This output is also not reported as an output flag, but it can be if needed for other purposes.

With reference to FIG. 14e EPOCH Learning Curve, shown is a sample learning curve for training the neural engine 1302. Smooth convergence of curve for training, validation and testing indicates the training evolution of the network. 65% of the audio data was used for training, 10% for validation and 25% for testing, but other percentages can also be used.

With reference to FIG. 14f Confusion Matrix, Confusion matrices for training, validation and testing are shown. These matrices illustrate the accuracy of the network in detecting the speech intervals 702 and the rate of false alarms. The overall rate of success is almost 91% and the false rate is almost 9%. The confusion matrix table 1412 (true and false positive rates) for the training signal is illustrated. Tables 1413, 1414 and 1415 show similar confusion matrices for validation, test, and overall, respectively. There are four confusion matrices; training, validation, test and overall. Each confusion matrix shows the relevant information about true positive/negative rates or false positive/negatives rates for each step. In an ideal case, we should have 100% at the entry (4,4) in each confusion matrix. All these confusion matrices are generated by the Matlab training tool or any other similar AI/ML application and are well-known in AI community.

The training of the AI-VAD engine 1002 is an offline procedure and as explained previously. Once the network 1302 is fully trained, it can be coded to any high-level language such as C or C++ for an embedded system real-time operation. The real-time C/C++ code, similar to the model shown, comprises three main functionalities. First the seven features 1329 are extracted in real-time and then fed into the trained neural engine 1302 which is now hard-coded in C. All the processing blocks can now be run in real-time and used to flag 1324 the speech activity 702.

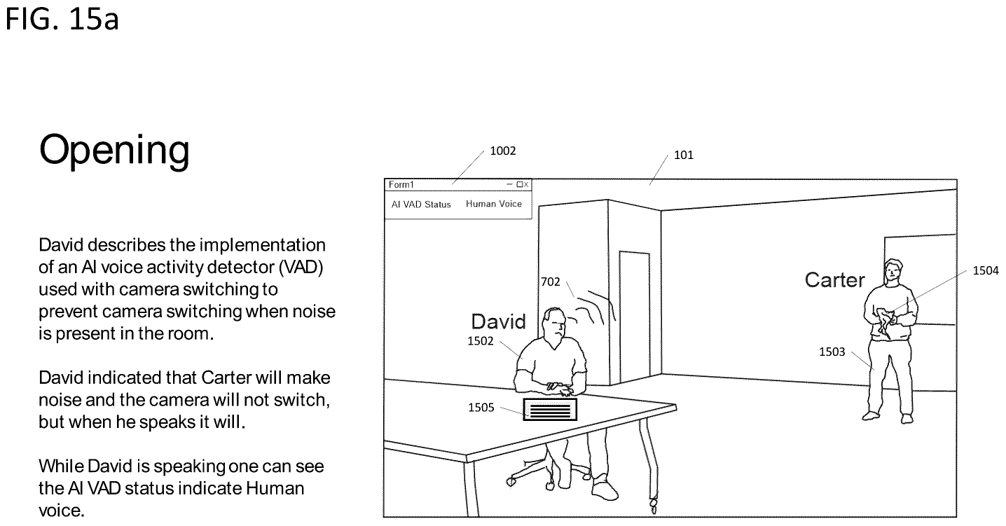

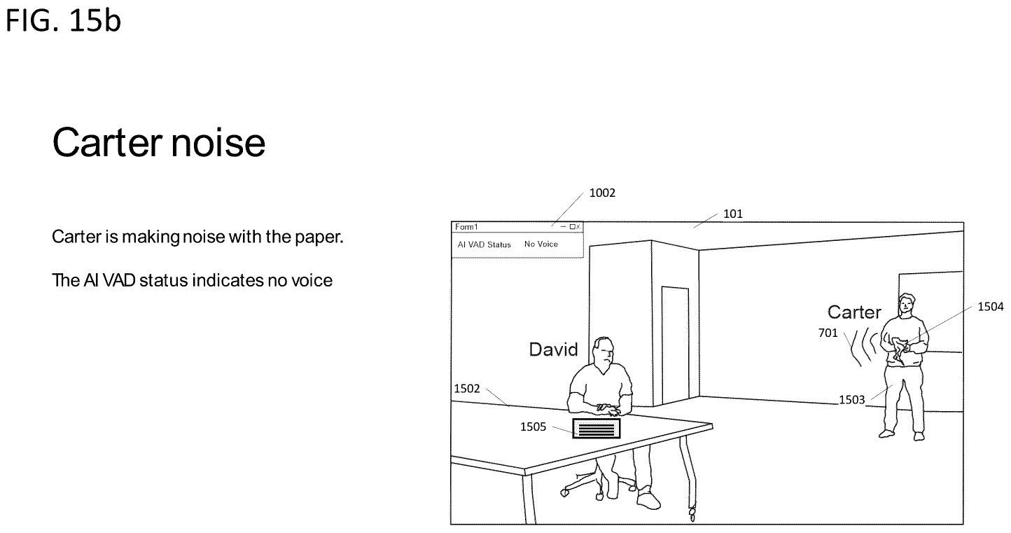

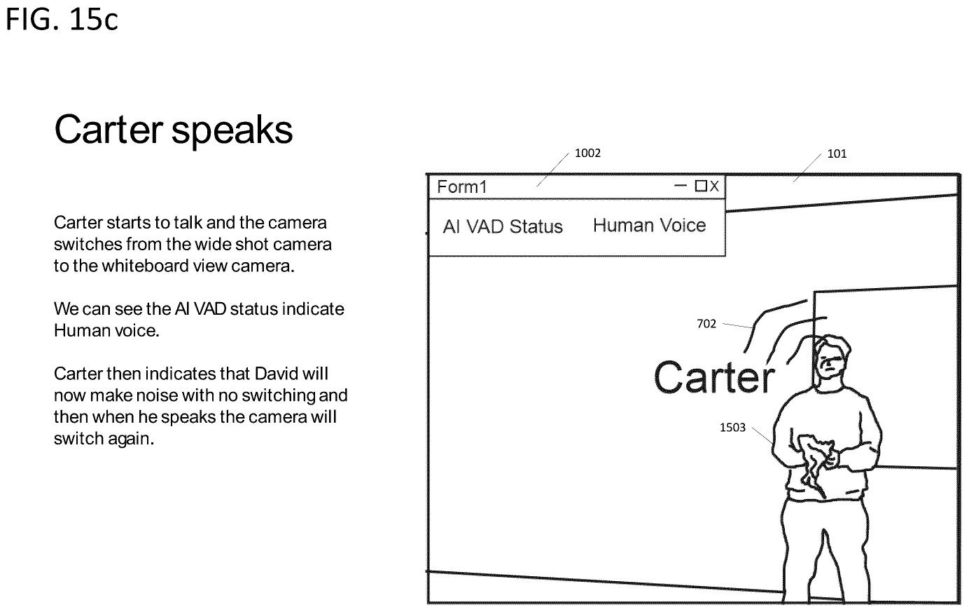

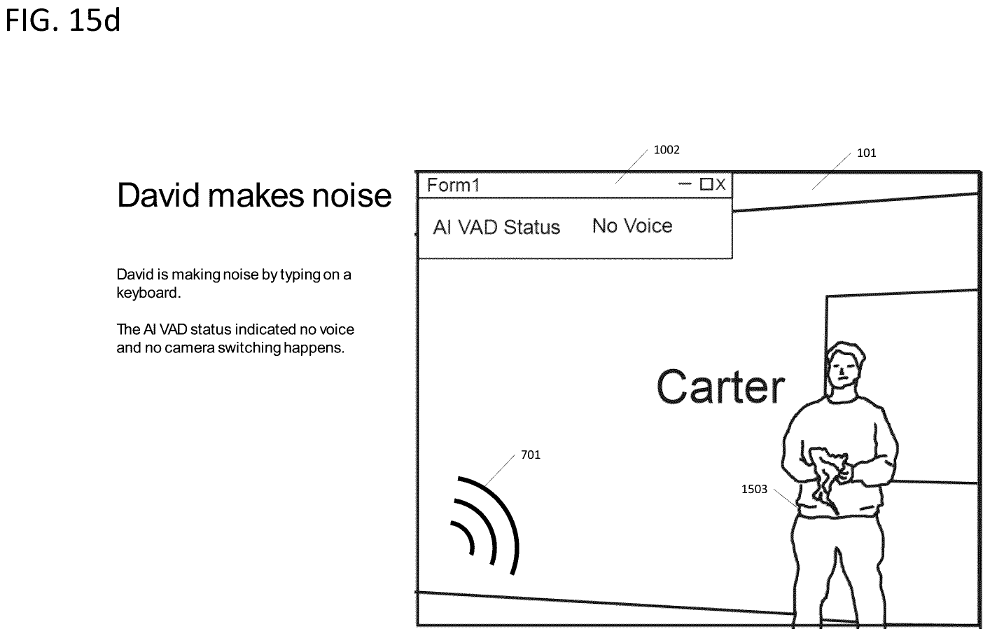

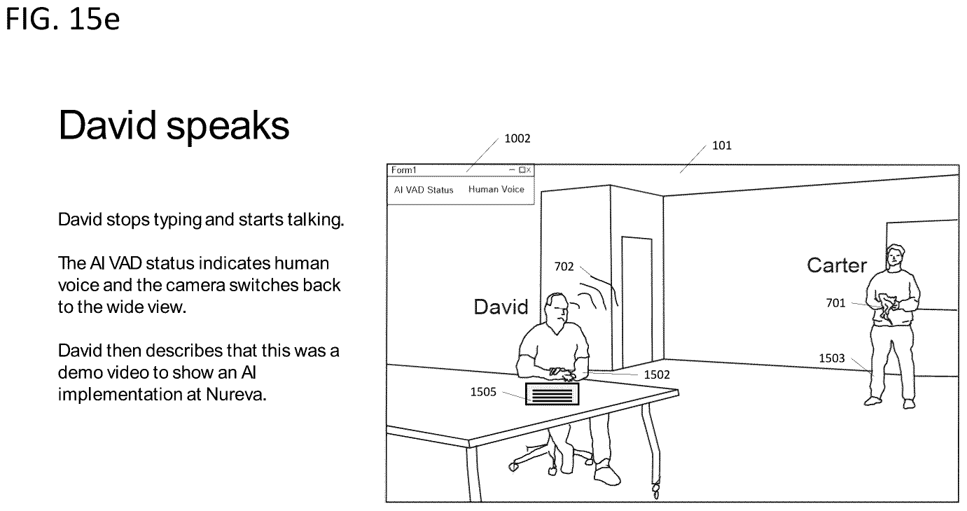

With reference to FIG. 15a, shown David 1502 describes the implementation of an AI voice activity detector (VAD) 1002 used with camera 103 (not shown) switching to prevent camera 103 switching when noise 701 is present in the room 101. David 1502 indicated that Carter 1503 would make noise 701 and the camera 103 would not switch, but when Carter 1503 speaks 702 it will switch. While David 1502 is speaking 702 one can see the AI-VAD 1002 status indicate Human voice 702.

With reference to FIG. 15b, shown Carter 1503 is making noise 701 with the paper 1504. The AI-VAD 1002 status indicates no voice 702.

With reference to FIG. 15c, shown Carter 1503 starts to talk and the camera 103 switches from the wide shot camera 103 to the whiteboard view camera 103. We can see the AI-VAD 1002 status indicate Human voice 702. Carter 1503 then indicates that David 1502 will now make noise 701 with no switching and then when he speaks the camera 103 will switch again. With reference to FIG. 15d, shown David 1502 is making noise 701 by typing on a keyboard 1505. The AI-VAD 1002 status indicated no voice, and no camera 103 switching happens since shown David 1502 is not speaking, only typing.

With reference to FIG. 15e, shown David 1502 stops typing 701 and starts talking 702. The AI-VAD 1002 status indicates human voice 702 and the camera 103 switches back to the wide view. David 1502 then describes that this was a demo video to show an AI implementation.

While specific embodiments of the invention have been described above, it will be appreciated that the invention may be practiced other than as described. The embodiment(s) described, and references in the specification to “one embodiment,” “an embodiment,” “an example embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

1. A method for voice activity detection (VAD) comprising:
defining, by a targeting processor, a plurality of virtual microphones in a shared 3D space,
wherein each virtual microphone is assigned a location coordinate in the shared 3D space;
determining, for each virtual microphone, a processed acoustic energy level continuously in real-time based on a microphone signal from a microphone array in the shared 3D space;
selecting at least one virtual microphone from the plurality of virtual microphones having a highest processed acoustic energy level as a targeted virtual microphone to focus the microphone array;
determining, for the targeted virtual microphone by a VAD engine, whether an acoustic type associated with the highest processed acoustic energy level is a speech sound or a non-speech sound;
setting a VAD flag for the targeted virtual microphone negative if the acoustic type is non-speech sound and positive if the acoustic type is speech sound; and
transmitting the VAD flag and the location coordinate of the targeted virtual microphone to at least one external process.

2. The method according to claim 1, wherein the location coordinate of the targeted virtual microphone is set as a current position of a talker within the shared 3D space.

3. The method according to claim 1, wherein the location coordinate of each virtual microphone is a distinct point in the shared 3D space comprising an X-coordinate, a Y-coordinate, and a Z-coordinate.

4. The method according to claim 1, wherein the VAD engine is a neural engine trained using labeled speech sounds, labeled non-speech sounds, and labeled silence-background noise.

5. The method according to claim 1, wherein the at least one external process is a camera director system.

6. The method according to claim 5, wherein the camera director system comprises:
a plurality of video cameras in the shared 3D space,
wherein each of the plurality of video cameras is associated with at least one predefined area within the shared 3D space,
wherein the camera director system:
automatically selects a targeted video camera from the plurality of video cameras if the location coordinate of the targeted virtual microphone is within the predefined area of the targeted video camera; and
transmits a video stream from the selected targeted video camera to a unified communication client for broadcast.

7. The method according to claim 6, wherein the at least one predefined area of each of the plurality of video cameras do not overlap in the shared 3D space.

8. The method according to claim 6, further comprising:
adjusting a zoom level, a field of view, or orientation of the selected target video camera based on the location coordinate of the targeted virtual microphone.

9. The method according to claim 6, wherein the camera director system comprises:
at least one video camera in the shared 3D space,
wherein the at least one video camera is associated with at least one predefined area in the shared 3D space,
wherein the camera director system transmits a video stream from the at least one video camera to a unified communication client for broadcast if the location coordinate of the targeted virtual microphone is within the at least one predefined area.

10. The method according to claim 1, further comprising:
continuously monitoring the targeted virtual microphone for speech or non-speech sound; and
setting the VAD flag to negative if non-speech sound is detected at the targeted virtual microphone.

11. The method according to claim 1, further comprising:
selecting a second virtual microphone from the plurality of virtual microphones having a second highest processed acoustic energy level as a second targeted virtual microphone;
determining, for the second targeted virtual microphone, whether the acoustic type is a speech sound or a non-speech sound by the VAD engine;
setting a second VAD flag for the second targeted virtual microphone negative if the acoustic type is non-speech sound and positive if the acoustic type is speech sound; and
transmitting the second VAD flag and the location coordinate of the second targeted virtual microphone to the at least one external process.

12. The method according to claim 1, wherein the microphone array comprises at least two microphones positioned in the 3D shared space.

13. The method according to claim 1, wherein the microphone signal for VAD training or inference is divided into a plurality of overlapping frames,
wherein a frame length of each overlapping frame is set to a value between 5 msec to 50 msec.

14. The method according to claim 13, wherein the overlap between successive frames is set to a value between 25% to 75%.

15. The method according to claim 14, wherein the frame length is 20 msec, and
wherein the overlap is 50%.

16. A non-transitory computer readable medium having stored thereon a program for a computer, the program executing steps of:
defining, by a targeting processor, a plurality of virtual microphones in a shared 3D space,
wherein each virtual microphone is assigned a location coordinate in the shared 3D space;
determining, for each virtual microphone, a processed acoustic energy level continuously in real-time based on a microphone signal from a microphone array in the shared 3D space;
selecting at least one virtual microphone from the plurality of virtual microphones having a highest processed acoustic energy level as a targeted virtual microphone to focus the microphone array;
determining, for the targeted virtual microphone by a VAD engine, whether an acoustic type associated with the highest processed acoustic energy level is a speech sound or a non-speech sound;
setting a VAD flag for the targeted virtual microphone negative if the acoustic type is non-speech sound and positive if the acoustic type is speech sound; and
transmitting the VAD flag and the location coordinate of the targeted virtual microphone to at least one external process.

17. An apparatus for performing voice activity detection (VAD) comprising:
a targeting processor defining a plurality of virtual microphones in a shared 3D space,
wherein each virtual microphone is assigned a location coordinate in the shared 3D space;
wherein the targeting processor:
determines, for each virtual microphone, a processed acoustic energy level continuously in real-time based on a microphone signal from a microphone array in the shared 3D space; and
selects at least one virtual microphone from the plurality of virtual microphones having a highest processed acoustic energy level as a targeted virtual microphone to focus a microphone array; and
a VAD engine,
wherein the VAD engine:
determines an acoustic type associated with the highest processed acoustic energy level for the targeted virtual microphone;
sets a VAD flag for the targeted virtual microphone negative if the acoustic type is non-speech sound and positive if the acoustic type is speech sound; and
transmitting the VAD flag and the location coordinate of the targeted virtual microphone to a camera director system,
wherein the camera director system controls a video stream of at least one video camera in the shared 3D space based on the VAD flag and the location coordinate of the targeted virtual microphone.
